(19) United States
(12) Patent Application Publication
(10) Pub. No.: US 2001/0044758 A1
(43) Pub. Date: Nov. 22, 2001

(54) Methods and systems for enabling efficient search and retrieval of products from an electronic product catalog

(76) Inventors: Iqbal Talib, Centreville, VA (US); Zubair Talib, Reston, VA (US)

Correspondence Address: George T. Marcou, KILPATRICK STOCKTON LLP, Suite 800, 700 13th Street, N.W., Washington, DC, 20005, US

(21) Appl. No.: 09/820,661

(22) Filed: Mar. 30, 2001

Related U.S. Application Data
(60) Provisional application No. 60/193,263, filed on Mar. 30, 2000.

(51) Int. Cl. G06F 17/60; G06F 17/30

(52) U.S. Cl. 705/27; 707/104.1; 707/10; 705/26; 707/200

(57) ABSTRACT

The present invention relates to systems and methods for searching a product catalog data collection in such a manner that it is easy to search, drill down, drill-up and drill across products in the data collection using multiple, independent hierarchical category taxonomies of the products in the product catalog data collection.

### CROSS-REFERENCE TO RELATED APPLICATIONS

This application claims priority to and incorporates by reference in its entirety provisional application Ser. No. 09/193,263, filed Mar. 30, 2000 entitled “METHODS AND SYSTEMS FOR ENABLING REVENUE MODELS BASED ON THE INSTANTANEOUS PREFERENCES OF ON-LINE USERS”.

### BACKGROUND OF THE INVENTION

1. Field of the Invention

The present invention relates to systems and methods for searching a product catalog data collection in such a manner that it is easy to search, drill down, drill-up and drill across products in the data collection using multiple, independent hierarchical category taxonomies of the products in the product catalog data collection.

2. Description of the Related Art

The present invention is directed to systems and methods for quickly and efficiently identifying products from an electronic product catalog.

It is well recognized that procurement systems have traditionally been manual, labor intensive and quite costly operations. Suppliers, for example will do mass mailings of catalogs to potential customers, the customers would browse the catalogs and select items to be purchased and then the customer would complete a paper order form, or call the supplier to order the items. The entire process, from preparing the catalog to receipt of the order, is very labor intensive and often took several weeks. If a supplier wanted to continually update its catalogs, or provide different price schedules to different customers, the printing, distribution and administrative costs would be substantial.

On a relatively small scale, some suppliers have offered catalogs through computer services, such as PRODIGY (TM). Employing PRODIGY (TM), a computer user can dial-up a service from home and select items to purchase from various catalogs maintained on the system. Upon selection, PRODIGY (TM) initiates the order with the supplier. While this has made significant improvements in typical procurement situations, there are still numerous needs remaining to be fulfilled.

The recent proliferation of electronic media has resulted in an explosion of electronic catalogs, for the managing parts within businesses and corporations and for selling products to consumers. Accompanying this growth is the continued investigation and implementation of different browsing strategies that offer intuitive techniques to aid users when searching and navigating large spaces of information. Electronic catalogs typically provide some form of search or navigation capability that users can employ in the location of parts or products.

Regarding this navigation capability, consider “Hierarchical Navigation” techniques as demonstrated by this instant invention. The majority of electronic catalogs have some category structure (e.g., node hierarchy) under which parts or products are categorized such as Cadis, Net. Commerce, Saqqara, Trilogy, Mediashare, iCat. This category hierarchy provides an alternative to search in the location of parts or products in an electronic catalog.

Parametric search techniques are based on the specification of values for attributes (or parameters). The simplest and most common form of search available in electronic catalogs today is keyword search (e.g. find the parts that have substring TP001 in their product descriptions). The next most common form of search is parametric search (e.g., find the product with an attribute “memory” whose value is “32 mb”). A more complex form of parametric search is enabled when it is combined with “forward checking”. Forward Checking involves a consistency maintenance mechanism that consists of a pruning technique that when implemented with a parametric search dynamically restricts attribute domains based on past attribute value assignments.

Forward checking permits a limited form of attribute relevance. It is limited because an attribute must be either relevant or irrelevant; there is no notion of strong or weak relevance. An attribute is defined as strongly relevant when it is relevant to all entities of the current node in the hierarchy while an attribute is considered weakly relevant when the attribute is relevant to a subset of the entities of the current node in the hierarchy and is considered irrelevant when the attribute is not relevant to any of the entities of the current node in a hierarchy. An entity represents concrete things in the world (e.g. products, services, people, etc.).

A well-recognized solution to these and other such difficulties has been the increased usage of search engines. Search engines are tools implemented on a computer and that search the contents of a given set of electronically stored records of a product for a particular search expression. A search expression at its most rudimentary level usually comprises one or more key words. If each of these key words is present within in an electronic record of a product, the computer flags that electronic record of the product for the user's later retrieval and review.

In this way, electronic records of products are not organized as to any predetermined organizational scheme, but rather are “organized” on the fly, according to a user's current needs. For example, if a user is looking for a “sweater,” he or she simply enters this keyword into a search engine, which then returns a listing of all electronically stored records of products containing these words. The user then retrieves and reviews the individual records, to determine whether each electronic record of a product is in fact relevant to the search expression.

A significant problem with the use of search engines is their finding too many products to flag for retrieval and review. For example, a ten thousand word record may refer to “sweater” only once, or multiple times but in an irrelevant manner, but a search engine would still flag the electronic record of a product for retrieval and review. The user, therefore, is left in the unenviable position of having to navigate through many electronic records of products that are tangentially, if at all, related to “sweater.”

Prior art approaches for refining search engines have not alleviated this problem. One approach is to provide the user the first few sentences of every record, along with its title, when providing a list of the electronic records of products that have been found to contain the search expression. Although this approach provides the user with a more immediate manner in which to determine whether a particular electronic record of a product is relevant, it is not a panacea. Frequently, for example, the first few sentences of an electronic record of a product do not provide a clue as to that record's relevance.

A second approach is to analyze the products in a statistical manner. For example, each electronic record of a product may be analyzed to determine a word frequency value that takes into account the number of times the search expression appears in an electronic record of a product, as compared to the document's length. The search engine then provides the user with a list of products containing the expression, in descending order by word frequency value. This approach is also far from perfect: the frequency with which an expression appears in an electronic record of a product does not necessarily correlate to the relevance of that product to the expression.

There is a need, therefore, for overcoming the inherent deficiencies in utilizing search engines to navigate vast numbers of electronically stored records regarding products. There is a need to ensure that a search engine yields a list of products that are significantly relevant to the search expression provided by the user. That is, there is a need for an engine that yields greater accuracy in performing a search of electronically stored records of products for only those products related to a given search expression.

FIG. 1 is a visual representation of an electronic product catalog 1. This electronic product catalog 1 is made up of a plurality of electronic records of products 2. Each electronic record of a product may consist of a single character, a string of characters, a plurality of strings of characters, an image, an audio file or any combination of the preceding. The size of the electronic product catalog 1 can be described by making reference to the number of electronic records of products 2 within it. Large product catalogs may contain millions of records regarding products.

The task of an electronic product catalog search engine is to provide the user with a list of products that the search engine calculates are likely to hold information chosen by the user. This list is compounded by using a search term or query 3. One method of compounding this list is a full-text algorithm. A “full-text” search algorithm identifies products that contain key term(s) in each and every electronic record of a product. In other words, the search process effectively identifies records such as record 2 that contain the search term 3. When the search is completed, a numerical count of the total number of electronic records for products containing the search term(s) is compiled and displayed along with a list of links to those products to allow the user to view the products. That is, the number of matches, e.g., “2,000 matches,” links and descriptions of the first few matching products are displayed to the user. The user reviews the number of matches and the provided descriptions of some of the matched products and either decides to try a different search in an attempt to shrink the number of matches or selects one listed link to access a particular electronic record.

One problem with these types of search engines is the often-large number of matches returned to the user. If a user enters the search term “sweater,” he/she may receive over 1 million matches. Almost no user will wade through all 1 million products looking for the best or specific electronic record that he/she needs.

If the user edits the search term(s), he/she may pare the number of matches down from 1 million to 200,000, but this number of matches is still too large for a user to view and use to make an effective decision. The user may then try to re-edit the search terms in an iterative process until the number of matches is manageable. However, this iterative process of re-editing search terms is time consuming and may frustrate the user before he/she receives the desired data.

In an effort to reduce this frustration, search engines were developed that categorize the products and provide the categories to the user so that he/she may reduce the number of products before executing a search using search term(s).

FIG. 2 shows some products 205, 210 and 215 from electronic product catalog 1. These products are categorized. The exemplary categories 250 shown are “Clothing,” “Pants,” “Corduroys,” “Jeans,” and “Cargo”. These categories 250 relate to product types.

One method of categorizing electronic records of products is to apply tags to each product. For example, if a product contains data which relates to a certain type, then that product is tagged with a unique tag identifying its relationship to that type. Other products that do not contain data related to that type are not tagged with that unique tag. These tags are later used to identify and retrieve electronic records of products containing data related to certain types. As a further example, if a product contains the word “pant,” then that product is tagged with a tag called “PA.”

The categorized electronic records of products 205, 210 and 215 are tagged with a single taxonomy because all of the categories 250 represent a class or subset of the taxonomy “Type.” Assuming all of the electronic records of products within electronic product catalog 1 are categorized, electronic product catalog 1 can be referred to as a “single-taxonomy, categorized electronic product catalog.”

Given these definitions, it is clear that a taxonomy is a hierarchical organization of categories and the various taxonomies and categories inherent to an electronic product catalog can be used to organize the electronic records of products in a electronic product catalog. This organization of the electronic records of the products, in turn, makes it easier to search for, retrieve, and display products containing specific data. In other words, a user may use the taxonomies and categories to search electronic product catalog 1 if the electronic records in electronic product catalog 1 are properly tagged.

Typically, taxonomies and categories are selected from among those characteristics and attributes which a user would intuitively think of to launch a search. For instance, a user attempting to find a pair of men's cargo pants would formulate a search based on certain intuitive characteristics, one being the “type” of clothing in electronic product catalog 1. This intuitive characteristic becomes a taxonomy. This search can be narrowed by using the attribute “Clothing”, “Men's Clothing” and “Pants.” These intuitive attributes are categories within the taxonomy.

One problem with most conventional search tools based on categories is that they only provide the user with a single taxonomy. For example, assume that a user searches using a taxonomy called “Product Type” and a category called “Pants” to identify all pants in an electronic clothing catalog. Suppose now, however, the user wishes to identify only “navy” pants. For a single taxonomy-categorized search, this means launching a new search because “navy” is neither an attribute nor a characteristic related to “Product Type.” Instead, “navy” is independent of product type and is related to a different taxonomy, such as “Color.” To try to alleviate this problem, many single-taxonomy, categorized search engines allow Boolean operations. Thus, if the user discovers that there are 100 different pant products, he/she may further refine this search by searching for the word “navy.” Thus, the user edits the search to be “pants” AND “navy.” This type of search modification is only marginally effective, for several reasons. First, the use of a Boolean search at this point usually entails the initiation of a new search. Second, the search engine, because it does not provide a taxonomy, cannot suggest terms for narrowing the search to the desired data, which requires the user to be clear about and know the Boolean query terms in advance. Third, such a search engine is inefficient because it requires an exponential increase in the number of operations to produce a set of hits.

Another problem with finding information in product catalog databases is that the user is often asked to choose multiple parameter attributes that end up defining a product that doesn't exist. For example, a user may be interested in finding a used automobile satisfying the following criteria: greater than 200 horsepower, less than 10,000 miles, greater than 50 miles per gallon fuel efficiency, and a price less than $10,000. After spending time naming all these parameters, the search may reveal that no product contains all these attributes. An alternative embodiment in the present invention is to have the user first specify the one or two attributes that are most important and then present the user only with valid, non-zero categories regarding products in the catalog. For example, in a “step search” process, the user might consider the attribute of in excess of 200 horsepower as the most important. The system would then inform the user how many cars there are that contain this attribute and allow the user to view these results from a variety of perspectives, like by price (e.g. 10 between $10,000-$20,000, 50 between $20,000-30,000 and 100 in excess of $30,000); by fuel efficiency (e.g. 80 between 10-20 mpg, 60 between 20-25 mpg and 20 in excess of 25 mpg); or by mileage (e.g. 50 between 0-20,000 miles, 50 between 20,000-50,000 miles and 60 in excess of 50,000 miles).

In an attempt to address data searching of ever increasing electronic product catalogs, many techniques have been developed. For example, U.S. Pat. No. 5,675,786 relates to accessing data held in large computer databases by sampling the initial result of a query of the database. Sampling of the initial result is achieved by setting a sampling rate which corresponds to the intended ratio at which the data documents of the initial result are to be sampled. The sampling result is substantially smaller than the initial query result and is thus easier to analyze statistically. While this method decreases the amount of data sent as a result of the query to the end user, it still results in an initial search of what could be a massive database. Further, dependent upon the sampling rate, sampling may result in a reduction in the accuracy of the information sent to the end user and may thus not provide the intended result.

Another example, U.S. Pat. No. 5,642,502 relates to a method and system for searching and retrieving documents in a database. A first search and retrieval result is compiled on the basis of a query. Each word in both the query and the search result are given a weighted value, and then combined to produce a similarity value for each document. Each document is ranked according to the similarity value and the end user chooses documents from the ranking. On the basis of the documents chosen from the ranking, the original query is updated in a second search and a second group of documents is produced. The second group of documents is supposed to have the more relevant documents of the query closer to the top of the list. While more relevant documents may be found as a result of the second search, the patent does not address the problems associated with the searching of a large database and, in fact, might only compound them. Additionally, the reference does not disclose the return categorized search results complete with counts of the number of records associated with those categories.

Yet another example, U.S. Pat. No. 5,265,244 relates to a method and apparatus for data access using a particular data structure. The structure has a plurality of data nodes, each for storing data, and a plurality of access nodes, each for pointing to another access node or a data node. Information, of a statistical nature, is associated with a subset of the access nodes and data nodes in which the statistical information is stored. Thus statistical information can be retrieved using statistical queries which isolate the subset of the access nodes and data nodes which contain the statistical information. While the patent may save time in terms of access to the statistical information, user access to the actual data documents requires further procedures.

U.S. Pat. No. 6,012,055 discloses a search system comprising multiple navigators switchable by tabs in the GUI, having the ability to cross-reference amongst said navigators. This is just a method for accessing different information sources, not a method for text-searching. Further, it does not offer user-categorized search results with counts.

However, none of these conventional systems provide users with a multiple-taxonomy, multiple-category search engine that allows users to search for documents, where the user is allowed to toggle among the multiple taxonomies as an aid to locating desired documents without constraints.

### SUMMARY OF THE INVENTION

The present invention overcomes the shortcomings identified above. More specifically, the present invention is a multiple-taxonomy, multiple category search tool that allows a user to “navigate” through an electronic product catalog using any of the taxonomies at any time.

In addition, the present invention overcomes the identified shortcomings of other search engines when small screen devices are employed to display search results. More specifically, the present invention transmits and displays categories for users to select from rather than providing users with long laundry lists of electronic record hits.

Through the presentation of categorized search results, the present invention allows an enormous database to be represented by a very small footprint, which is ideal for wireless devices.

Further, the present invention provides a mechanism for “slicing-and-dicing” the information in a database, thus, allowing the creation of personalized or customized data collections of product information.

The present invention further provides such advantages by means of a system for searching an electronic product catalog, said system comprising: an organizer configured to receive search requests, said organizer comprising: an electronic product catalog having at least two entries; wherein the electronic product catalog is organized into at least two taxonomies; wherein each of the at least two taxonomies is associated with at least two categories; wherein the entries correspond to at least one of the at least two taxonomies and also correspond to at least one of the at least two categories; and a search engine in communication with the electronic product catalog, wherein said search engine is configured to search based on the at least two taxonomies and based on the at least two categories, wherein the search engine returns, in response to a search request identifying at least a first taxonomy of the at least two taxonomies, a list of the categories associated with the at least first identified taxonomy, along with the number of entries associated with each of the categories associated with the at least first identified taxonomy.

The above advantages are further provided through the present invention, which is a system for searching an electronic product catalog, said system comprising: means for networking a plurality of computers; and means for organizing executing in said computer network and configured to receive search requests from any one of said plurality of computers, said means for organizing comprising: an electronic product catalog having at least two entries; wherein the electronic product catalog is organized into at least two taxonomies; wherein each of the at least two taxonomies is associated with at least two categories; wherein the entries correspond to at least one of the at least two taxonomies and also correspond to at least one of the at least two categories; and means for searching in communication with the electronic product catalog, wherein said means for searching is configured to search based on the at least two taxonomies and based on the at least two categories, wherein the means for searching returns, in response to a search request identifying one of the at least two taxonomies, a list of the categories associated with the identified taxonomy, along with the number of entries associated with each of the categories associated with the identified taxonomy.

The above-identified advantages are further provided through a system for searching a electronic product catalog, said system comprising: means for networking a plurality of computers; and means for organizing executing in said computer network and configured to receive search requests from any one of said plurality of computers, said means for organizing comprising: an electronic product catalog having at least two entries; wherein the electronic product catalog is organized into at least two taxonomies; wherein each of the at least two taxonomies is associated with at least two categories; wherein the entries correspond to at least one of the at least two taxonomies and also correspond to at least one of the at least two categories; and means for searching in communication with the electronic product catalog, wherein said means for searching is configured to search based on the at least two taxonomies and based on the at least two categories, wherein the means for searching returns, in response to a search request identifying one of the at least two taxonomies, a list of the categories associated with the identified taxonomy, along with the number of entries associated with each of the categories associated with the identified taxonomy.

Additionally, the above-identified advantages are provided through an article of manufacture comprising: a computer usable medium having computer program code means embodied thereon for searching an electronic product catalog, the computer readable program code means in said article of manufacture comprising: computer readable program code means for communicating a search request to a search engine, the search engine being in communication with an electronic product catalog; wherein the electronic product catalog has at least two entries; wherein the electronic product catalog is organized into at least two taxonomies; wherein each of the at least two taxonomies is associated with at least two categories; wherein the at least two entries correspond to at least one of the at least two taxonomies and also correspond to at least one of the at least two categories; computer readable program code means for querying of the electronic product catalog by the search engine based on the communicated search request; wherein a communicated search request identifies at least one of the at least two taxonomies; and computer readable program code means for returning of a list of the categories associated with the at least one identified taxonomy, along with the number of entries associated with each of the categories associated with the at least one identified taxonomy as a response to the querying of the electronic product catalog.

When potential users navigate an electronic product catalog powered by the present search technology, they are greeted with an “aerial” view of the entire electronic product catalog. The invention replicates real-world customer service by shaping itself to the needs, priorities, and discretion of the user. Users thus have the ability to intuitively navigate through huge amounts of information by using keywords and categories in conjunction with the different taxonomies of the electronic product catalog. These navigation features are a significant aspect of this electronic product catalog search that differentiates it from conventional search technology.

When a user knows what he/she is looking for, the invention quickly uncovers the right information without forcing the user to go through numerous irrelevant search results. The real power of the search technology comes when users do not know or are only vaguely familiar with what they want. In these instances, where a user needs to browse through all or part of the data listings, keyword searches with categorized search results (from different taxonomies) will facilitate easy navigation by providing the user with context and scope relating to the search results and by giving a user the information he/she needs to find the electronic records of products and information he/she required.

The present invention provides users with an aerial view of the electronic product catalog at all times during a search. Users remain aware of where they stand in their search and how many electronic records potentially satisfy their query. More importantly, users receive categorized search results that provide summary information on the products in the electronic product catalog that remain within the parameters of a search.

Users of the present invention can look for information using keywords they feel will help them refine their search. The system will locate every electronic record in the electronic product catalog that contains that particular word or phrase and instantly return all the electronic record categories (at the category level of the search as then being conducted) that have associated products. The search results indicate how many electronic records exist within each applicable category, and allow users to easily hone down on the specific segment of the electronic product catalog he/she is interested in and, more importantly, to disregard all other irrelevant information.

For example, if a user enters the search term “corduroy,” the system would search all the electronic records in the electronic product catalog that contained the term “corduroy.” Rather than returning a long list of numerous search results that satisfy the user's query, the present invention provides the user with the categories that are associated with the remaining electronic records and indicates how many electronic records exist under each category. This functionality assists the user to further refine his/her search and disregard the irrelevant information.

These searched data collections provide users with summary information (categorized search results) about the data collection being searched. Users need not use pull-down menus or fill in any “required” fields to construct the parameters of their search (product type, color, size, brand, price, etc.). Rather, search results display only the valid categories and indicate how many electronic records are associated with each applicable category. Users are thus presented with the available options in the electronic product catalog (through a dynamic aisle and shelf structure) and can drill down through hierarchically organized electronic product catalog information or switch among taxonomies to find what they require.

In instances where data collection information can be associated with more than one independent category structure (e.g., product type, color, size, brand, price, promotions), users of the present invention can switch among taxonomies of the electronic product catalog at any time during the search process and look at information from different perspectives, although in one embodiment of the present invention “step search” taxonomies are not introduced until the user has drilled down to a specific category in the “Product Type” taxonomy. For example, the “Style,” “Color,” and “Size” taxonomies are “step search” taxonomies because they are not presented as options to the user until the user has selected a clothing category in the “Product Type” taxonomy. Likewise, taxonomies for “Processor Speed,” “Hard Disk Size,” “Monitor Size,” and “Memory Amount” are not presented as options to the user until the user has selected a computer category in the “Product Type” taxonomy.

Step search taxonomies preferably apply to some products in the electronic catalog, while traditional taxonomies, such as “Price,” “Promotions” and “Brands”, apply to all products in the electronic catalog. A “Monitor Size” taxonomy is obviously inapplicable to a user searching for clothing products as much as a “Style” taxonomy is inapplicable to a user searching for a computer. A “Price” taxonomy, however, would apply to a user searching for any product.

Users thus have the ability to navigate through an electronic product catalog using categorized search results that are provided from several different perspectives, or taxonomies. Amazingly, the whole process is extremely intuitive and very easy to use. By using keywords in conjunction with the different taxonomies of an electronic product catalog and by drilling down hierarchical categories within each taxonomy, users are always left with a refined set of listings without having to go through irrelevant search results.

If a user clicks on the “Price” tab, the present invention will instantly reorganize all the electronic records that remain within the parameters of the search (regardless of number) and present the same information categorized by a “Price” taxonomy of the electronic product catalog. Switching among taxonomies is possible at any point in the search process. Further, certain taxonomies are designated as “step search” taxonomies are presented to the user as preferred options when the user has drilled down to a specific category in the “Product Type” taxonomy.

The data collections replicate existing business paradigms from the physical world on to the Internet landscape. The dynamic aisle and shelf structure and humanistic interface can help companies retain current users, acquire new customers, and maximize the value of their online traffic. This functionality also spawns new and innovative revenue and business models that help monetize eyeballs and turn Internet browsers into buyers.

It is understood that the Internet provides an unprecedented opportunity to collect and analyze data. The present invention also improves the collection of user data because users navigate through an electronic product catalog by drilling down hierarchically organized categories using their mouse or wireless keypad. Each time the user clicks down a category or switches his/her taxonomy to a different category structure, there is the opportunity to accumulate real-time marketing information that can be responded to interactively or later collected, analyzed and used to derive revenues. Cumulatively, this additional information about customers (demographics, decision patterns, trends, preferences) is more meaningful and can help manage customer relations and product development.

### BRIEF DESCRIPTION OF THE DRAWINGS

FIG. 1 is a simplified diagram of an electronic product catalog;

FIG. 2 is a simplified view of various electronic records;

FIG. 3 is a system in accordance with a preferred embodiment of the present invention;

FIGS. 4-8 are screen shots a user would see when using an embodiment of the present invention as applied to an electronic catalog of clothing items;

FIG. 9 is a representation of how a query interacts with indices and how those indices relate to electronic records of products in an electronic product catalog according to an embodiment of the present invention;

FIGS. 10-12 represent process steps a user would go through to drill down to a set of electronic records in an electronic product catalog, in accordance with an embodiment of the present invention;

FIG. 13 is a system in accordance with a preferred embodiment of the present invention;

FIG. 14 shows a searching process in accordance with an embodiment of the present invention;

FIG. 15 is a screen shot of a categorizer in accordance with an embodiment of the present invention;

FIG. 16 is a representation of categories and reads in accordance with an embodiment of the present invention;

FIG. 17 illustrates a method of distributing, indexing and retrieving data in a distributed data retrieval system, according to an embodiment of the present invention;

FIG. 18 illustrates the distribution of data information and the formation of sub-collections in a distributed data retrieval system, according to an embodiment of the present invention;

FIG. 19 illustrates an inverted index from which a sub-collection view can be generated in a distributed data retrieval system, according to an embodiment of the present invention;

FIG. 20 illustrates a sub-collection view, according to an embodiment of the present invention;

FIG. 21 illustrates the paths of communication forming a network between a central computer and a series of local computers in a distributed data retrieval system, according to an embodiment of the present invention; and

FIG. 22 illustrates a global view, according to an embodiment of the present invention.

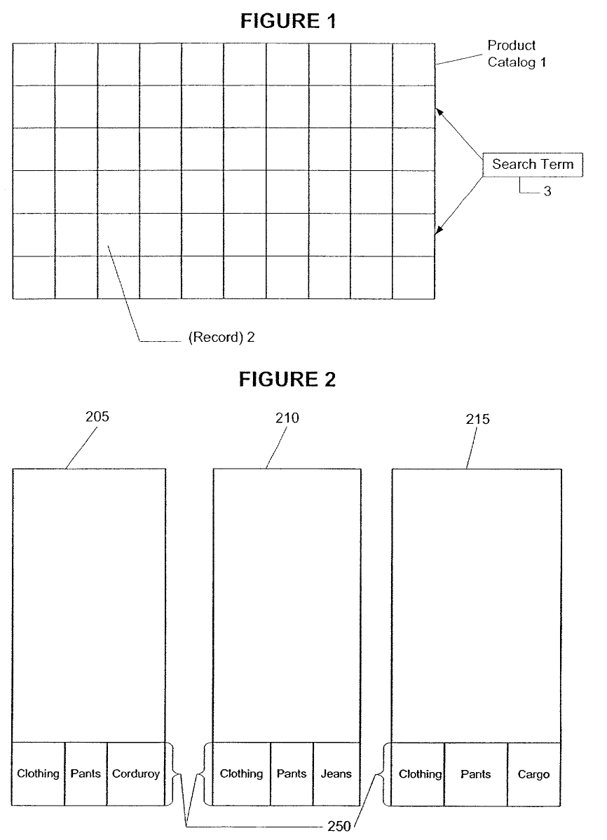

### DETAILED DESCRIPTION OF THE INVENTION

On-line computer services, such as the Internet, have grown immensely in popularity over the last decade. Such an on-line computer service can provide access to a hierarchically structured electronic product catalog where information within the electronic product catalog is accessible at a plurality of computer servers which are in communication via conventional telephone lines or T1 links, and a network backbone. For example, the Internet is a giant internetwork created originally by linking various research and defense networks (such as NSFnet, MILnet, and CREN). Since the origin of the Internet, various other private and public networks have become attached to the Internet.

The structure of the Internet is a network backbone with networks branching off of the backbone. These branches, in turn, have networks branching off of them, and so on. Routers move information packets between network levels, and then from network to network, until the packet reaches the neighborhood of its destination. From the destination, the destination network's host directs the information packet to the appropriate terminal, or node. For a more detailed description of the structure and operation of the Internet, please refer to “The Internet Complete Reference,” by Harley Hahn and Rick Stout, published by McGraw-Hill, 1994.

A user may access the Internet, for example, using a home personal computer (PC) equipped with a conventional modem. Special interface software is installed within the PC so that when the user wishes to access the Internet, a modem within the user's PC is automatically instructed to dial the telephone number associated with the local Internet host server. The user can then access information at any address accessible over the Internet. One well-known software interface, for example, is the Microsoft Internet Explorer (a species of HTTP Browser), developed by Microsoft.

Information exchanged over the Internet is often encoded in HyperText Mark-up Language (HTML) format. HTML encoding is a kind of markup language which is used to define electronic record content information. As is well known in the art, HTML is a set of conventions for marking portions of an electronic record so that, when accessed by a parser, each portion appears with a distinctive format. The HTML indicates, or “tags,” what portion of the electronic record the text corresponds to (e.g., the title, header, body text, etc.), and the parser actually formats the electronic record in the specified manner. An HTML document sometimes includes hyper-links which allow a user to move from document to document on the Internet. A hyper-link is an underlined or otherwise emphasized portion of text or graphical image which, when clicked using a mouse, activates a software connection module which allows the users to jump between documents (i.e., within the same Internet site (address) or at other Internet sites). Hyper-links are well known in the art.

One popular computer on-line service is the Web which constitutes a subnetwork of online documents within the Internet. The Web includes graphics files in addition to text files and other information which can be accessed using a network browser which serves as a graphical interface between the on-line Web documents and the user. One such popular browser is the MOSAIC web browser (developed by the National Super Computer Agency (NSCA)). A web browser is a software interface which serves as a text and/or graphics link between the user's terminal and the Internet networked documents. Thus, a web browser allows the user to “visit” multiple web sites on the Internet.

Typically, a web site is defined by an Internet address which has an associated home page. Generally, multiple subdirectories can be accessed from a home page. While in a given home page, a user is typically given access only to subdirectories within the home page site; however, hyper-links allow a user to access other home pages, or subdirectories of other home pages, while remaining linked to the current home page in which the user is browsing.

Although the Internet, together with other on-line computer services, has been used widely as a means of sharing information amongst a plurality of users, current Internet browsers and other interfaces have suffered from a number of shortcomings. For example, the organization of information accessible through current Internet browsers and organizers such as Microsoft Internet Explorer or MOSAIC, may not be suitable for a number of desirable applications. In certain instances, a user may desire to access information predicated upon product type as opposed to by subject matter or keyword searches. In addition, present Internet organizers do not effectively integrate product-related information in a consistent manner.

In addition, given the large volume of information available over the Internet, current systems may not be flexible enough to provide for organization and display of each of the kinds of information available over the Internet in a manner which is appropriate for the amount and kind of data to be displayed.

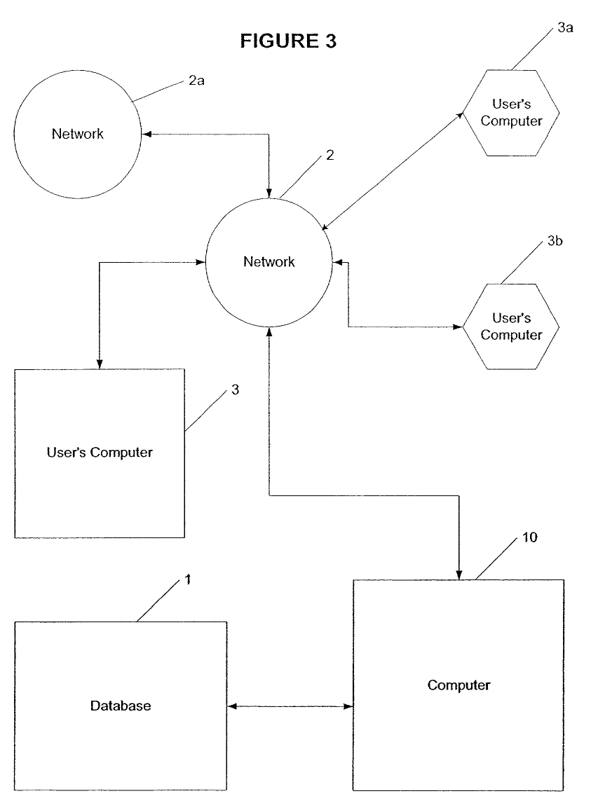

FIG. 3 is a system overview in accordance with a preferred embodiment of the present invention. A plurality of user computers 3, 3a and 3b are coupled to a network 2. Network 2 is also coupled to another network 2a which itself is coupled to other computers (not shown). Computer 10 is also coupled to network 2. Coupled to computer 10 is electronic product catalog 1. Electronic product catalog 1 contains a plurality of electronic records (not shown).

The network 2 may be a private or public network, an intranet or Internet, or a wide or local area network which not only connects the user 3 but other users 3a, 3b and other networks 2a to computer 10.

For ease of understanding, in the discussion which follows, the network 2 will comprise the Internet, though this need not be the case.

It should be understood that electronic product catalog 1 comprises a multiple-taxonomy, categorized electronic product catalog. In such an electronic product catalog the records have been tagged or otherwise categorized by more than one taxonomy. For example, the records in electronic product catalog I have been categorized by the taxonomies “Price,” “Type,” “Brands” and “Promotion.” In this example, the records have also been categorized by additional “step search” taxonomies, but these taxonomies (such as “Color,” “Style” and “Size” if the user has selected a clothing category, or “Monitor Size” and “Memory Amount” if the user has selected a computer category) are not presented as options until the user has drilled down to a specific category in the “Product Type” taxonomy.

Each taxonomy, in turn, comprises a number of categories. To distinguish the categories and taxonomies used to tag electronic records within electronic product catalog 1 from those selected by the user, the categories and taxonomies used to tag the electronic records will be referred to as “product categories” and “product taxonomies.”

In one embodiment of the invention, computer 10 receives search requests in the form of data (hereafter referred to as “search-related data”) via network 2 from user computer 3. Search-related data comprise a search term entered by a user to initiate a keyword search, or a taxonomy or category selected by the user by “clicking on” a portion of a screen.

The category and/or taxonomy selected by the user and sent to computer 10 is a way for the user to navigate a Web site. As such, the category will be referred to as a “navigational category” and the taxonomy will be referred to as a “navigational taxonomy.”

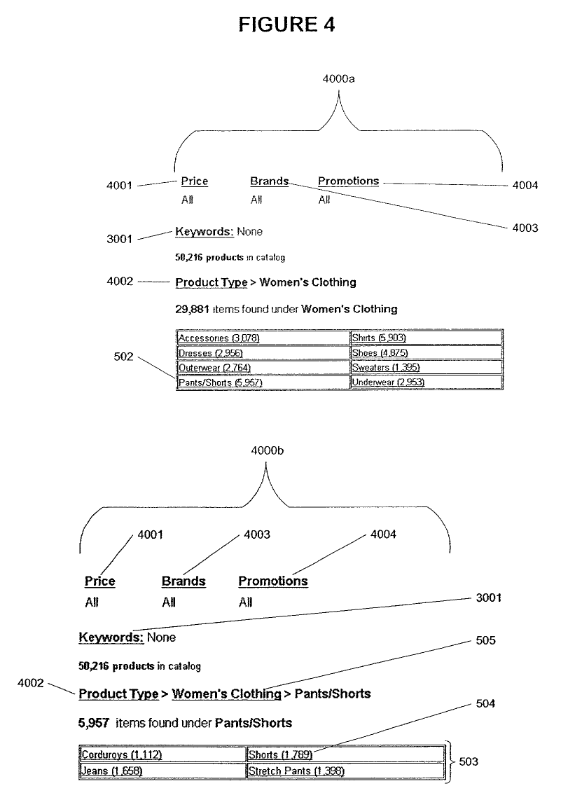

For example, when the user accesses a web site, like web site 4000a or 4000b in FIG. 4, he/she is presented with an initial screen which displays taxonomies 4001, 4002, 4003 and 4004, namely “Price” 4001, “Product Type” 4002, “Brands” 4003 and “Promotions” 4004. The user may then insert a search term 3001 and select the “Product Type” taxonomy 4002. After selecting a taxonomy, the user then selects a category 502.

Once computer 10 receives the search-related data, the present invention utilizes the navigational taxonomy 4002 and category 502 in the user's search request to determine sub-categories from the hierarchy associated with the navigational taxonomy and category.

For instance, if the category 502 comprises “Pants/Shorts,” then the process might yield sub-categories 503 shown in FIG. 4000b. One such sub-category 503 is “Shorts” 504. Subcategories 503 will be referred to as “navigational sub-categories.”

Once computer 10 has determined the sub-categories 503, it then can launch a search directed to electronic product catalog 1.

It will be appreciated that the present invention envisions computer 10 launching search queries aimed at electronic product catalog 1 using sub-categories 503 which are not selected by the user. Rather, these sub-categories are dynamically selected by computer 10 based on the taxonomies and/or categories input by the user.

According to one embodiment of the present invention, a search query may be carried out in a number of ways.

For example, in one illustrative embodiment of the present invention computer 10 launches a search query comprising a search term 3001, a taxonomy 4002 and sub-categories 503 directed to electronic product catalog 1. Computer 10 compares the navigational taxonomy and sub-categories 503 to the product taxonomies and sub-categories making up electronic product catalog 1. If an electronic record is tagged with a product taxonomy and a sub-category which matches a navigational taxonomy and sub-category, then that electronic record must contain characters which are responsive to the user's search. After a match is detected, computer 10 compares the search term 3001 against only those electronic records having matching taxonomies/categories.

Once the matching electronic records have been identified, computer 10 generates a numerical count of all of the electronic records of products within electronic product catalog 1 which have characters which match the search term. This numerical count is further broken down by sub-category. For example, FIG. 4 shows “5,957” unique clothing items for the category “Pants/Shorts” 502. Within this, “1,789” relate to sub-category “Shorts” 504.

In another embodiment of the invention, computer 10 launches a search query comprising only a category or sub-category without a search term. This enables a user to “drill-down” through electronic product catalog 1 merely by selecting a narrower and narrower sub-category. In yet another embodiment of the invention, computer 10 is adapted to launch search queries comprising only a search term or terms. It should be noted that computer 10 initiates any one of these types of search queries at any level of drill-down.

In an illustrative embodiment of the present invention, a user may also drill-up through a hierarchy of categories/sub-categories. For example, once a user has drilled down and reached the level represented by screen 4000b in FIG. 4, he/she may click on the category “Women's Clothing” 505, and upon receiving this category as search-related data, computer 10 returns to screen 4000a in FIG. 4. In addition to drilling-up, the user 3 may switch taxonomies at any point in a drill-down or up. For example, the user can click on the taxonomy “Price” 4001 in FIG. 4 and be presented with categories corresponding to this taxonomy and all previous search constraints are maintained. In all cases, when the user clicks on or otherwise selects a taxonomy, category or sub-category, computer 10 compares the search-related data to a hierarchy as previously explained. A search is then launched by computer 10 using navigational sub-categories which result from this comparison.

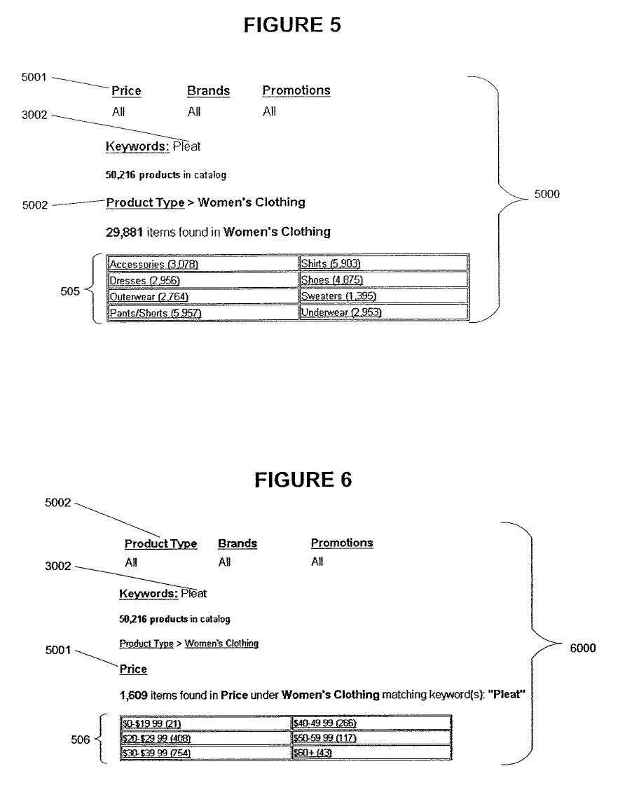

FIGS. 5 and 6 display screens 5000 and 6000 depicting other examples of how results from a search using two or more taxonomies 5001, 5002 can be displayed. Beginning with FIG. 5, there is shown an example of an initial screen 5000 which displays categories 505 which make up a “Product Type” taxonomy 5002. Though only a few categories are shown, it should be understood that categories 505 may comprise any topic, or some subset. In the example shown in FIG. 5, the user types in a search term “pleat” 3002 and then clicks on the “Price” taxonomy 5001. The present invention, however, is not limited to displaying the results of a search against only one taxonomy on one screen at the same time. Rather, the present invention can display the results of searches against multiple taxonomies on one screen at the same time.

Computer 10 then selects navigational sub-categories 506 which correspond to the taxonomy “Price” and subsequently launches a search query against electronic product catalog 1 using search term 3002, taxonomy 5001 and sub-categories 506. It should be noted that both taxonomies 5001, 5002 are provided to enable a user to initiate a search using either taxonomy.

Continuing, FIG. 6 depicts an example of a screen 6000 generated from the results of initiating the just described search query. As shown, the screen 6000 displays categories 506 which are navigational sub-categories related to the taxonomy “Price” 5001. In addition, the number of records containing characters matching the search term “pleat” 3002 is also displayed. As before, this number is displayed as a total and is also broken down for each sub-category. For example, next to the sub-category “$20-$29.99” is the number “408” which indicates the number of articles of pleated Women's Clothing within electronic product catalog 1 that are priced between $20 and $29.99.

It should be understood that the user need not input an additional keyword to further narrow his/her search. Instead, computer 10 generates intuitive sub-categories 506 which are presented to the user for the very purpose of narrowing his/her search. In addition, the number of matching records for each sub-category is displayed without the need for the user to individually launch separate searches aimed at each sub-category.

It should be understood that the terms “category” and “sub-category” are relative terms and in some instances may be used interchangeably.

The ability to switch among taxonomies, to drill-down or up, or to switch among taxonomies while drilling down or up enables the user to navigate a Web site or other user interfaces and corresponding electronic product catalog 1 with great ease. This ease-of-navigation can be used to enable new revenue models. In one embodiment of the invention, new revenue models, such as advertising models, are enabled from such easy-to-navigate Web sites.

Taxonomies and categories/sub-categories can be analogized to aisles and shelves in a grocery store. A user finds the shelf (“category”) he/she is interested in somewhere in an aisle (“taxonomy”) comprised of multiple shelves. In brick-and-mortar grocery stores (i.e., physical, not Internet stores), companies have sought to catch the eye of a shopper as he/she scans a shelf by placing advertisements next to their product. Ideally, the shopper will notice the ad and be enticed to buy the product over other similar items on the same shelf that have no advertisement associated with them. The present invention envisions the enabling of new advertising revenue models based on the selection of aisles and shelves (i.e., taxonomies and categories).

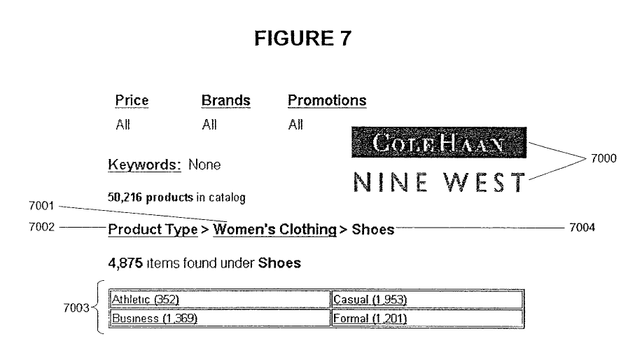

FIG. 7 depicts advertisements 7000 generated when a user has drilled down to the sub-category “Shoes” 7004 under “Women's Clothing” 7001 in the “Product Type” taxonomy 7002. Using the aisle and shelf analogy again, the user first selects the “Product Type” aisle, scans the aisle and determines that he/she is interested in those shelves associated with “Women's Clothing,” selects those shelves and is presented with a list of shelves which are related to “Women's Clothing.” The user can then select the specific shelf or sub-category 7003 which he/she is interested in. Unlike a physical grocery store, the “aisle” that the user has “walked” down is actually two aisles. All of the products on the shelf have been organized by “Price” and by “Product Type.” Thus, as the user “stands” in front of the shelf associated with “Women's Clothing,” he/she is also “standing” in front of a shelf which is also associated with some subset of the “Price” aisle. In the physical world, it is as if each end of an aisle has two signs, one labeled “Price” and another labeled “Type.” Down the aisle are categories of items which are associated with a specific product type and particular prices.

In one embodiment of the invention, computer 10 selects advertisement 7000, based on the taxonomies, categories and/or search terms input by a user, in this case, based on the user's selection of the sub-category “Shoes” 7004. The selection of such an advertisement will be referred to as “attaching” an advertisement based on the search-related data input.

Computer 10 attaches advertisement 7000 only when a user selects the sub-category “Shoes” 7004 for example. More generally, computer 10 attaches advertisements based on real-time, instantaneous actions (e.g., selection of a taxonomy or category) received from the user. It should be understood that any type of advertisement may be attached by computer 10 in response to search-related data supplied by the user. The search-related data supplied by user begins as preferences in the mind of the user. As the user navigates through a Web site he/she makes choices based on those preferences. These choices are manifested in the taxonomies, categories, sub-categories and search terms selected or otherwise input by the user.

Computer 10 also attaches an advertisement at any point during a drill-down or up, when a user switches taxonomies, and/or upon the input of a search term.

The ability to attach advertisements based on real-time preferences of a user is useful. In particular, this capability allows on-line publishers to use new models to generate revenue. Publishers will no longer need to rely on a circulation rate model. Instead of selling on-line advertisements based solely on historical, circulation-related criteria, advertisers can establish revenue models based on real-time user preferences. In one illustrative embodiment of the invention, publishers can charge different dollar amounts by category level. For example, a publisher may create a multi-tiered advertising rate structure. Such a model may comprise a first or lower tier and subsequent higher tiers. In an illustrative embodiment of the invention, the lower tier may comprise a relatively low dollar amount with each subsequent higher tier comprising an increased dollar amount. In addition to linking each tier to a dollar amount, computer 10 links each tier or tiers to a category level. For instance, the category “Shoes” 7004 may represent one category level while the taxonomy “Type” 7002 may represent another. In an illustrative embodiment of the invention, computer 10 links each of the levels to a dollar amount. So, one level may be linked to a low dollar amount while another level may be linked to a higher dollar amount.

A publisher may generate revenue from such a model as follows. If a business wants its advertisement to be seen whenever a user is attempting to locate women's clothing, a publisher may charge a fee of $1.00. Each time a user selects the category “Women's Clothing” 7001 the user would see an ad corresponding to this search level. If, however, a business only wants to advertise when a user wants an article about women's shoes, then the publisher may charge a higher amount, say $2.00 to allow ad 7000 to be displayed when a user clicks on the sub-category “Shoes” 7004. In one embodiment of the invention, computer 10 attaches ads to categories located farther down a hierarchy for a higher cost than ads closer to the beginning of the hierarchy. The rationale behind such an advertising model is that businesses are willing to pay higher advertising rates to reach those users who are engaged in focused searches. In an alternative embodiment, higher rates are applied at higher categories because more people view these categories than individual sub-categories. As can be imagined, any number of models can be created. These include, but are not limited to, the following: a model where computer 10 attaches ads to categories located farther down a hierarchy for a higher cost than categories at the beginning of the hierarchy; or a model where computer 10 attaches ads for a premium cost to categories within a hierarchy. In these models, the advertising rate was determined by the breadth or “direction” of the search, i.e., drilling up or drilling down. In another model, the advertising rate is based on the popularity of the category or on the uniqueness of the category.

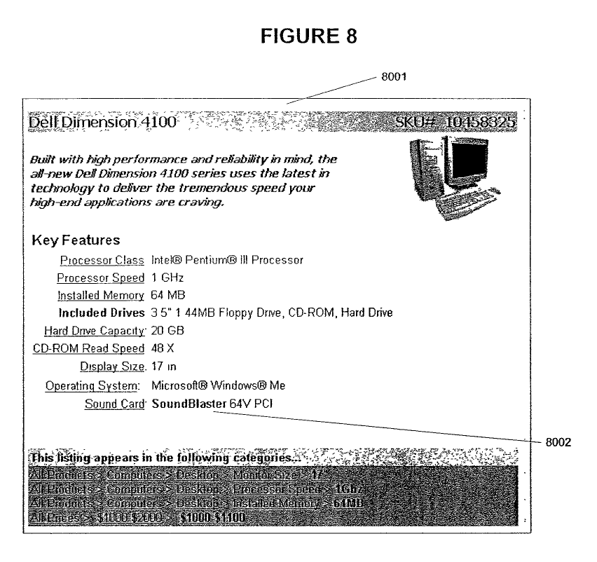

FIG. 8 depicts screen 8001 generated in accordance with an alternative embodiment of the present invention. In this embodiment, computer 10 generates advertisements 8001 when the user initiates a search which includes a search term which matches a term used within ad 8001.

For purposes of explaining FIG. 8, it is assumed that the user has drilled down using a “Product Type” taxonomy and category “Computers” and entered the search term “Sound Blaster”. Upon entering the search term “Sound Blaster”, advertisement 8001 is displayed. The ad 8001 does not comprise a “banner” advertisement, such as ad 7000 in FIG. 7. Instead, it is a searchable “display” advertisement for a particular product, in this case a computer. In an illustrative embodiment of the invention, computer 10 attaches an advertisement when the search initiated by the user contains a character-string which matches a character-string in the advertisement. In FIG. 8, the advertisement 8001 is attached because it contained the word “Sound Blaster” 8002. This is a form of syndicating an advertisement from a manufacturer to a user. The present invention allows the manufacturer to build his/her advertisement for the product in any format and have it distributed. Thus, the present invention acts as a collector and syndicator of data.

Real-time user preferences are manifested in the taxonomies, categories and search terms selected or otherwise inputted into a Web site. As illustrated above, these stored preferences can be used to focus a search by selecting intuitive, navigational sub-categories from a hierarchy of categories/sub-categories. These preferences also trigger the display of ads which are tailored to the users' preferences or at least to the perceived preferences of such a user.

These real-time preferences can be used in other ways envisioned by the present invention, as well. For example, the present invention envisions computer 10 tracing user preferences. This tracing is done in near real-time and allows a business to follow a user as he/she works her way through a website using taxonomies and a hierarchy of categories. In an additional embodiment of the invention, computer 10 stores the taxonomies and categories selected by a user to determine, for example, the products and services preferred by the user. From this, a product manufacturer can determine to which category or taxonomy within the electronic product catalog hierarchy their product ads should be attached.

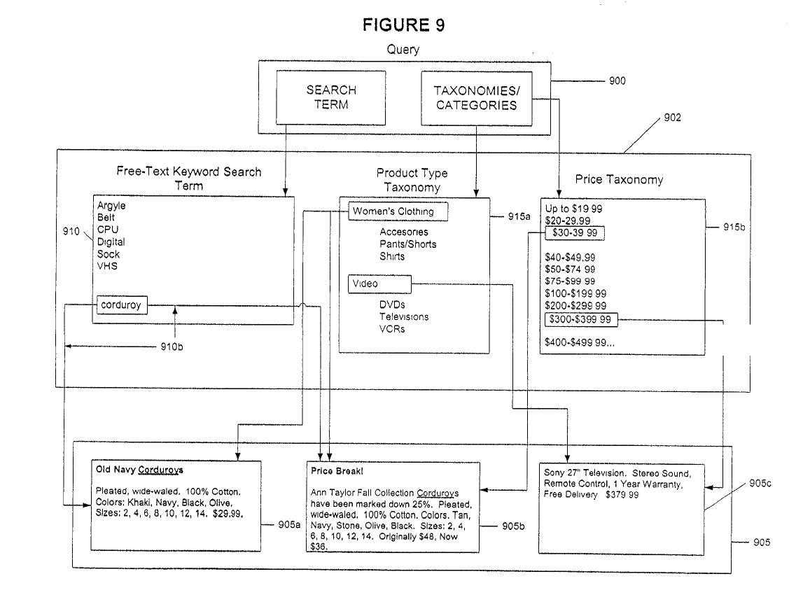

FIG. 9 provides a schematic of the data as it is stored and organized in an electronic product catalog in accordance with a preferred embodiment of the present invention. The electronic product catalog 905 contains many electronic records of products, 905a, 905b, and 905c. In this example, an electronic record is a single unit of identifiable data. Examples of electronic records include individual Web pages, text documents, collections of video, still image, audio data, or any combination of these. It should be noted that there are other types of data that may be grouped together to form an electronic record.

Three exemplary electronic records are shown in FIG. 9. Each of electronic records 905a, 905b and 905c is a plain text document describing a particular product available in the electronic product catalog.

Indices 910, 915a and 915b are used to access electronic records in electronic product catalog 905. Inverted index 902 contains a listing of all the key words and phrases 910 in all of the electronic records of products in electronic product catalog 905, and other indices 915a and 915b. Examples of such key words and phrases include “argyle,” “belt,” “CPU,” “digital,” “sock” and “VHS.” Attached to each of these key words and phrases are links 910b. These links reference each electronic record in index 905 that contains these words and phrases.

Indices 915a and 915b represent different taxonomies of electronic product catalog 905. As shown by the headings, index 915a is a “Product Type” taxonomy of electronic product catalog 905 and index 915b is a “Price” taxonomy of electronic product catalog 905.

These three indices 910, 915a and 915b are used to access the electronic records in electronic product catalog 905 in three different ways. Index 910 receives search terms or phrases and is scanned to locate those key word or phrases. When a hit is discovered, the number of links 910b that reference into electronic product catalog 905 is then determined.

Indices 915a and 915b provide electronic record collection lists of their respective contents in response to user input. As an example, if the user clicks on the “Product Type” taxonomy, all of the categories within that taxonomy are displayed. Two of those categories include “Women's Clothing” and “Video.” As shown in FIG. 9, each of these categories is divided into sub-categories like “Accessories,” “Pants/Shorts,” “Shirts,” “DVDs,” “Televisions” and “VCRs.”

Index 915b is a taxonomy of electronic product catalog 905 based on “Price.” Within taxonomy 915b are categories. The exemplary categories are price ranges by dollar amount.

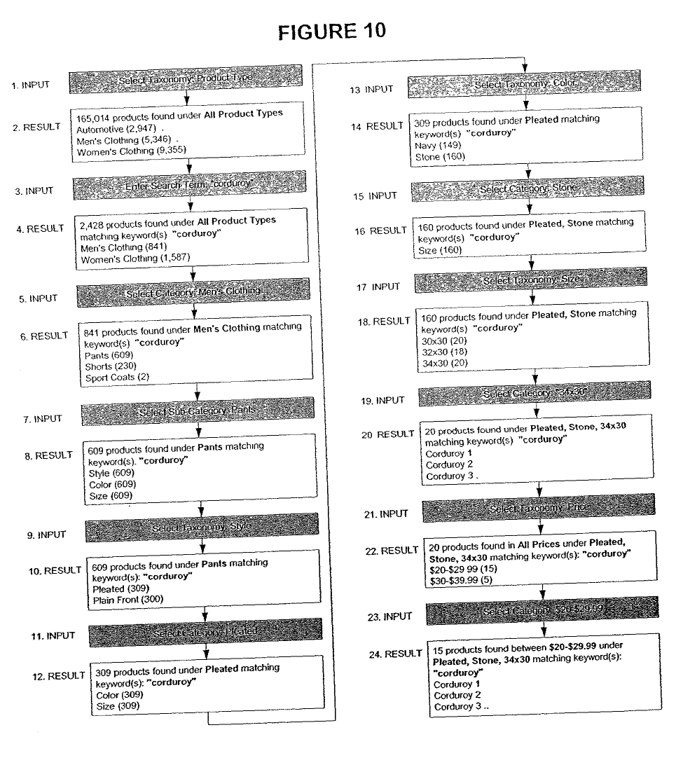

By having multiple taxonomies of the single electronic product catalog, multiple paths are possible to reach the same electronic records. FIG. 10 shows one set of queries from a user and the system responses that represent a path a user may take to reach the electronic records he/she desires. In this example, the user begins by typing in a search term against the “Product Type” taxonomy, however in an alternative embodiment of the present invention, the user could begin a search against multiple taxonomies. In the example given the search term is “corduroy.” The present invention queries term index 910 and determines that 2,428 electronic records in the electronic product catalog have the word “corduroy” within them.

The present invention then determines the categories that are associated with the search term “corduroy”. For example, all of the electronic records that have the search term “corduroy” in them are categorized in the categories “Men's Clothing” and “Women's Clothing.” Invalid, zero-member categories are never presented. The user selects the “Men's Clothing” category and the present invention then searches through index 915a to determine how many electronic records within each of the sub-categories also are associated with the search term “corduroy.” As shown in FIG. 10, only 2 electronic records organized into the “Sport Coats” category contain the keyword “corduroy” while 609 electronic records organized into the “Pants” category contain the keyword “corduroy.” Thus the present invention compounds all of this data and provides it to the user. It should be noted that by pushing data back to the user, in this case a glimpse of the organization of the categories, the user can learn how best to proceed with drilling down into the data.

The user responds to the list of sub-categories provided by the present invention by selecting one. In this example, the user selects the sub-category “Pants”.

In this example of the present invention, the system responds by introducing “step search” taxonomies (“Style,” “Color,” and “Size”) because the user has now drilled down to a specific category in the “Product Type” taxonomy. For example, the “Style,” “Color,” and “Size” taxonomies are “step search” taxonomies because they are not presented as options to the user until the user has selected a clothing product type. Once “step search” taxonomies are presented, the user can drill down any of the “step search” taxonomies, or continue to refine his/her search by switching back to other taxonomies or keyword queries. In this example, the user selects the “Style” taxonomy, and the system responds by cross-matching the 609 electronic records against the categories within the taxonomy “Style.” Thus, the system generates a electronic product catalog of these 609 electronic records as organized by style (ie., 309 pairs of pants are pleated while the other 300 are plain front).

The user selects the “Pleated” category. Because there are no additional sub-categories under this category, the system presents the options of two other “step search” taxonomies, namely “Color” and “Size”. The user responds by selecting the “Color” taxonomy, and the system responds by cross-matching the 309 electronic records against the categories within the taxonomy “Color.” Thus, the system generates an electronic product catalog of these 309 electronic records as organized by color.

The user selects the “Stone” category. Because there are no additional sub-categories under this category, the system presents the option of the remaining “step search” taxonomy, namely “Size”. The user responds by selecting the “Size” taxonomy, and the system responds by cross-matching the 160 electronic records against the categories within the taxonomy “Size.” Thus, the system generates an electronic product catalog of these 160 electronic records as organized by size.

The user selects the “34×30” category. Because there are no additional sub-categories under this category and no additional “step search” taxonomies, the system responds by providing a list of all 20 results. At this point, the user continue to refine this list further, the user switches to the “Price” taxonomy in response.

The system responds by cross-matching the 20 electronic records against the categories within the taxonomy “Price.” Thus, the system generates a electronic product catalog of these 20 electronic records as organized by price range (i.e., $20-$29.99 has 15, etc.).

The user responds by selecting the “$20-$29.99” category. The system responds by providing a list of all 15 electronic records that match the search. Thus, the listed electronic records are a match of the taxonomy “Product Type;” the search term “corduroy;” the category “Men's Clothing;” the sub-category “Pants;” the taxonomy “Style;” the category “Pleated;” the taxonomy “Color;” the category “Stone;” the taxonomy “Size;” the category “34×30;” the taxonomy “Price” and the category “$20-$29.99.”

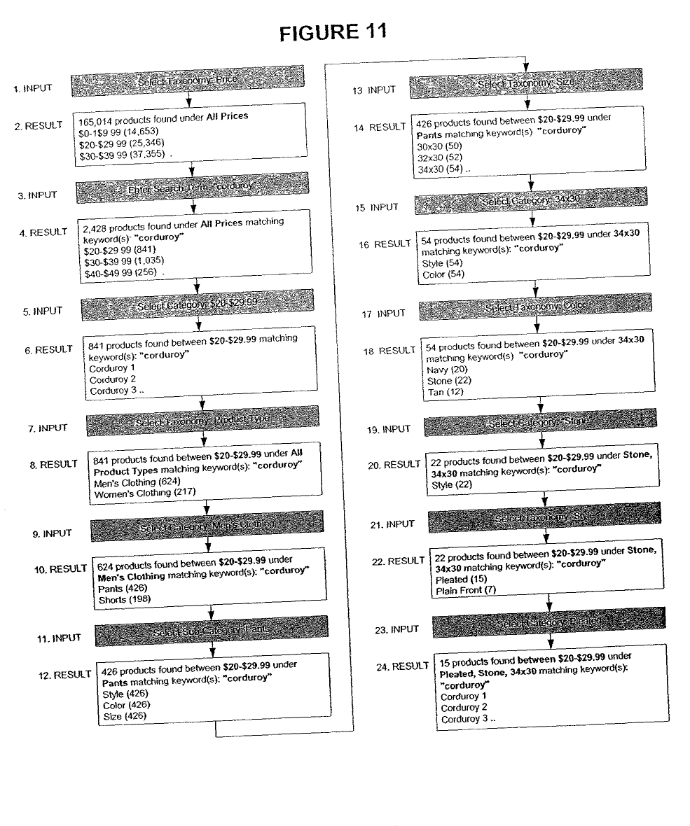

FIG. 11 shows another set of user queries and system responses that represent another path the user may use to get to the same set of electronic records. The user begins this search by requesting details about the taxonomy “Price.” The system responds by returning the list of price ranges with a count of how many electronic records are associated with each price range.

The user responds by entering the search term “corduroy.” The system cross-matches the search term “corduroy” in free-text term index 910 with each price range. This produces a category list of price ranges with the number of electronic records associated with the search term “corduroy” in parentheses.

The user responds by selecting one of the listed categories. Following with the example given in conjunction with FIG. 10, the user selects “$20-$29.99.”

Because there are no sub-categories under the category “$20-$29.99,” the system responds by providing a list of all 841 records that are associated with the search term “corduroy.” This list is unruly for a user to wade through so the user clicks on the “Product Type” taxonomy in response. The system responds by cross-matching all of the categories in the taxonomy “Product Type” with the selected category “$20-$29.99.” Thus, the system generates a data collection of these 841 records as organized by Product Type (i.e., Men's Clothing has 624, Women's Clothing has 217).

The user responds to these categories by selecting “Men's Clothing.” The system responds by cross-matching the sub-categories within “Product Type.” In this example, the sub-categories are types of menswear, such as “Pants” and “Shorts.” Once the cross-matching is completed, the system provides the user with a list of appropriate sub-categories with how many records match the search so far.

The user responds by selecting “Pants.” In this example, the system responds by introducing “step search” taxonomies (“Style,” “Color,” and “Size”) because the user has now drilled down to a specific category in the “Product Type” taxonomy. The user selects the “Size” taxonomy, and the system responds by cross-matching the 426 electronic records against the categories within the taxonomy “Size.” Thus, the system generates a electronic product catalog of these 426 electronic records as organized by size (i.e., 50 pairs of pants are sized 30×30, 52 pairs are sized 32×30, 54 pairs are sized 34×30, etc.).

The user selects the “34×30” category. Because there are no additional sub-categories under this category, the system presents the options of two other “step search” taxonomies, namely “Color” and “Style”. The user responds by selecting the “Color” taxonomy, and the system responds by cross-matching the 54 electronic records against the categories within the taxonomy “Color.” Thus, the system generates an electronic product catalog of these 54 electronic records as organized by color.

The user selects the “Stone” category. Because there are no additional sub-categories under this category, the system presents the option of the remaining “step search” taxonomy, namely “Style”. The user responds by selecting the “Style” taxonomy, and the system responds by cross-matching the 22 electronic records against the categories within the taxonomy “Style.” Thus, the system generates an electronic product catalog of these 22 electronic records as organized by style.

The user selects the “Pleated” category. Because there are no additional sub-categories under this category and no additional “step search” taxonomies, the system responds by providing a list of all 15 results. In this example, the records match the taxonomy “Price;” the search term “corduroy;” the category “$20-$29.99;” the taxonomy “Product Type;” the category “Men's Clothing;” the sub-category “Pants;” the taxonomy “Size;” the category “34×30;” the taxonomy “Color;” the category “Stone;” the taxonomy “Style” and the category “Pleated.” This is a different search path to the one described in FIG. 10, yet it yields the same results.

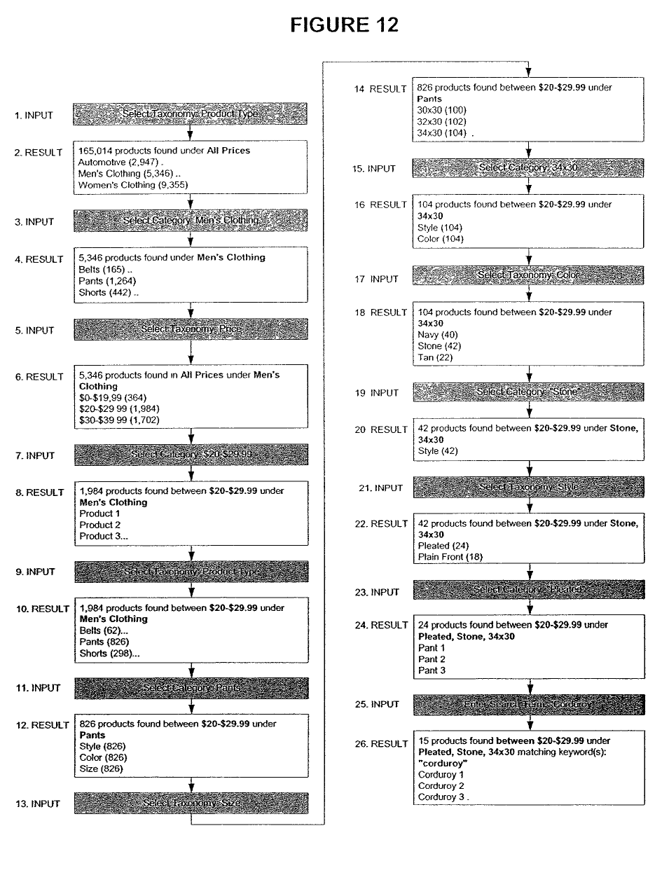

FIG. 12 shows yet another set of user queries and system responses that represent yet another path the user may travel in order to obtain the desired electronic records. The user begins by selecting the “Product Type” taxonomy. The system responds by listing all of the categories with all the electronic records associated with each category in parentheses. In this example, each product type category is listed along with its number of associated electronic records.

The user responds by selecting one of the listed categories. Again, the user selects “Men's Clothing.” The system responds by listing the sub-categories under the selected category along with the number of associated electronic records in parentheses.

The user responds by selecting the taxonomy “Price.” The system responds by cross-matching all of the categories in the taxonomy “Price” with the selected category “Men's Clothing.” The system then provides the user with a list of categories in the “Price” taxonomy. Examples of categories in this taxonomy are “$20-$29.99” and “$30-$39.99.”

The user responds by selecting a particular category. Following with the above examples, the user selects the category “$20-$29.99.” Because there are no sub-categories under the category “$20-$29.99,” the system responds by providing a list of all 1,984 records that are associated with the search term “corduroy.” This list is unruly for a user to wade through so the user switches back to the “Product Type” taxonomy in response. The system responds by cross-matching all of the categories in the taxonomy “Product Type” with the selected category “$20-$29.99.” The system then provides the user with a list of categories in the “Product Type” taxonomy. Examples of categories in this taxonomy are “Belts” and “Pants.”

The user responds by selecting the sub-category “Pants.” In this example, the system responds by introducing “step search” taxonomies (“Style,” “Color,” and “Size”) because the user has now drilled down to a specific category in the “Product Type” taxonomy. The user selects the “Size” taxonomy, and the system responds by cross-matching the 826 electronic records against the categories within the taxonomy “Size.” Thus, the system generates a electronic product catalog of these 826 electronic records as organized by size (i.e., 100 pairs of pants are sized 30×30, 102 pairs are sized 32×30, 104 pairs are sized 34×30, etc.).

The user selects the “34×30” category. Because there are no additional sub-categories under this category, the system presents the options of two other “step search” taxonomies, namely “Color” and “Style”. The user responds by selecting the “Color” taxonomy, and the system responds by cross-matching the 104 electronic records against the categories within the taxonomy “Color.” Thus, the system generates an electronic product catalog of these 104 electronic records as organized by color.

The user selects the “Stone” category. Because there are no additional sub-categories under this category, the system presents the option of the remaining “step search” taxonomy, namely “Style”. The user responds by selecting the “Style” taxonomy, and the system responds by cross-matching the 42 electronic records against the categories within the taxonomy “Style.” Thus, the system generates an electronic product catalog of these 42 electronic records as organized by style.

The user selects the “Pleated” category. Because there are no additional sub-categories under this category and no additional “step search” taxonomies, the system responds by providing a list of all 24 results.

To narrow down this list further, the user responds by entering the search term “corduroy.” The system receives this query, matches electronic records associated with the search term “corduroy” from free-text term index against the terms stored therein and cross-matches those electronic records associated with the search term “corduroy” with the listed electronic records. This produces a list of 15 electronic records that match the search. In this example, the records match the taxonomy “Product Type;” the category “Men's Clothing;” the taxonomy “Price;” the category $20-$29.99;” the taxonomy “Product Type;” the category “Men's Clothing;” the sub-category “Pants;” the taxonomy “Size;” the category “34×30;” the taxonomy “Color;” the category “Stone;” the taxonomy “Style;” the category “Pleated;” and the search term “corduroy.” This is a different search path to the one described in FIGS. 10 and 11, yet it yields the same results.

These three examples demonstrate the versatility of the present invention. First, the user is not required to go through a specific path to reach the desired number of electronic records. While the above examples show only three paths to reach the desired set of electronic records, it can be appreciated that there are multiple paths to reaching the same set of electronic records.

This plurality of paths is achieved by the independence of the taxonomies shown in FIG. 9. By keeping these taxonomies independent, the user may switch between which taxonomy he/she wishes to use to consider the data and make queries into electronic product catalog 905. The level of the search that the user uses to make a decision to switch among taxonomies is also arbitrary and up to the user, with the exception of any “step search” taxonomies that have not yet been presented as options at that stage of the search. This allows users who are more proficient in developing searches to use their proficiency in one taxonomy index to whittle the number of electronic records down before going into another taxonomy index to finish the search where the user is less proficient, and vice versa.

Another feature of the present invention is the pushing of data to the user. As noted above, the user receives category and sub-category information when a query via a search term is used earlier in the process. As noted above, suppose the user is looking for linen pants, instead of corduroy. By typing the search term “linen,” the system will provide the category list to the user so that he/she can drill down into the data. Thus, if there were a sub-sub-category of “pants” the user would eventually see that sub-sub-category and make the association between “linen” and “pants.” Thus the user comes in contact with a useful category or sub-category that he/she can use to search for desired information. Additionally, if the character-string “linen” were contained in any product description, all such products would appear in the search set following the user's entry of such keyword query.

These electronic records are categorized so that associations are made between the categories and sub-categories in the multiple taxonomies and the electronic records. In addition, terms within the electronic records that correspond to terms in the free text term index are determined. Associations are then made between these electronic records and the various categories and terms in the indices.

Another advantage of the present invention is the way results are provided to the user. As noted in the many examples above, much of the sifting through the electronic product catalog is done via the categories and sub-categories. In a preferred embodiment, there are many more electronic records in the electronic product catalog than there are categories. As an example, a search term may be associated with thousands of electronic records, but only one category. Providing a list of thousands of electronic records requires a lot of data handling in both the transmission of the data to the user, as well as the displaying of the data to the user. Providing a list of only one category is much less data to transmit and display. This makes the invention ideal for use with devices with small screens, such as cell phones, pagers, and personal digital assistants (PDAs) and palm-held devices.

FIG. 16 is a representation of a portion of the data stored in structure 902 and how that data is organized in accordance with a preferred embodiment of the present invention. Node 1605 represents the category “Men's Clothing” from the “Product Type” taxonomy. Node 1610 represents the sub-category “Pants.” Node 1615 represents the sub-category “Belts.” Node 1620 represents the sub-category “$20-$29.99” from the “Price” taxonomy. Record 1625 represents a single record.

Linking the nodes and electronic records are category code words. Leading into node 1605 is a category code word called “MC.” Leading into node 1610 is a category code word called “PA.” Leading into node 1615 is category code word “BE.” Leading into Record 1625 are links R1 and R2. This representation shows how the various categories relate to each other and the electronic records.

In one embodiment of the present invention, these path names are stored in inverted index 902 and used to retrieve electronic records. This structure provides several advantages. In one embodiment of the present invention, these path names are stored in inverted index 902 and used to retrieve electronic records. This structure provides a means to perform Boolean operations on the path names to calculate category count results and to identify records that are identified by those category paths.

It will be appreciated that large global collections of data can be broken down into smaller sub-collections. The sub-collections can be stored independently one from the other, as in separate physical locations or simply in separate data tables within the same physical location, and can be connected one to the other through a network. As data are added to the large global collection overall, it can be sent and added to individual sub-collections and/or can be formed into a further sub-collection. For instance, data entered by educational institutions and scientific research facilities can be stored independently in their own data storage facilities and connected to one another via a network, such as the Internet. Thus, as can be seen, the present invention can be implemented with very little or no change in the present protocol for data collection and storage.

It will be appreciated that the present invention provides a search interface that can aggregate disparate databases and make the disparate databases searchable through one interface.

Once the individual sub-collections have been identified, each performs its own indexing function. In carrying out the indexing function, each sub-collection creates its own sub-collection taxonomy consisting of statistical information generated from what is commonly referred to as an inverted index. An inverted index is an index by individual words listing electronic records which contain each individual word. The indexing function itself can be carried out in any method. For example, indexing can be performed by assigning a weight to each word contained in a document. From the weights assigned to the words in each document, a sub-collection view (i.e., the statistical information derived from the inverted index) is created upon completion of the indexing function. Regardless of how the sub-collection indexing is carried out, each sub-collection will have its own independent sub-collection view based upon that sub-collection's inverted index. When data information is added to the sub-collection, the indexing function is carried out again and the sub-collection's view can be re-compiled from a new inverted index.

Upon completion of each sub-collection view, certain statistical information about the sub-collection view is gathered by a global collection manager to form a global collection of parameters, statistics, or information. The global collection manager may either request from each sub-collection that it send its sub-collection view, and/or each of the sub-collections may spontaneously send the sub-collection view to the global collection manager upon completion. Regardless of whether the taxonomies are requested or spontaneously sent, upon collection at the global collection manager of all of the sub-collection's views, the global collection manager builds a “global view” on the basis of the sub-collection views. Necessarily, the global view is likely to be different from each of the individual sub-collection views. Once the global view has been compiled, it is sent back to each of the sub-collections.

In this manner then, a distributed data retrieval system is built and is ready for search and retrieval operations. To search for a particular piece of data information, a system user simply enters a search query. The search query is passed to each individual sub-collection and used by each individual sub-collection to perform a search function. In performing the search function, each sub-collection uses the global view to determine search results. In this manner then, search results across each of the sub-collections will be based upon the same search criteria (i.e., the global view).

The results of the search function are passed by each individual sub-collection to the global collection manager, or the computer which initiated the search, and merged into a final global search result. The final global search result can then be presented to the system user as a complete search of all data information references.

These time savings are increased as the length of the path is increased. If the entire path length from base node to document node includes fifty of these node-to-node or node-to-document links, the search is reduced from 400 characters to 100.

The labeling of these paths also reduces computation time for other searches. For example, if the search is a proximity search (i.e., Is store X within 5 miles of apartment Y?), the present invention can be used to make this determination. For example, if in one path to the document associated with store X is the path name “SC” for South Carolina and in the corresponding path to the document apartment Y is the path name “MD” for Maryland, the system can immediately determine that the answer to this query is No by merely referring to the path names.

It should be noted that other variations are possible with this embodiment of the invention without departing from the scope of the invention. For example, the number of characters used to describe a path is not limited to two and may in fact be any number of characters. Additionally, the path names need not be limited to letters but may encompass numbers, symbols or a combination of letters, numbers and symbols. In addition, once the paths between the base node and each document are determined, they may be stored within the electronic records as tags in a preferred embodiment of the present invention.

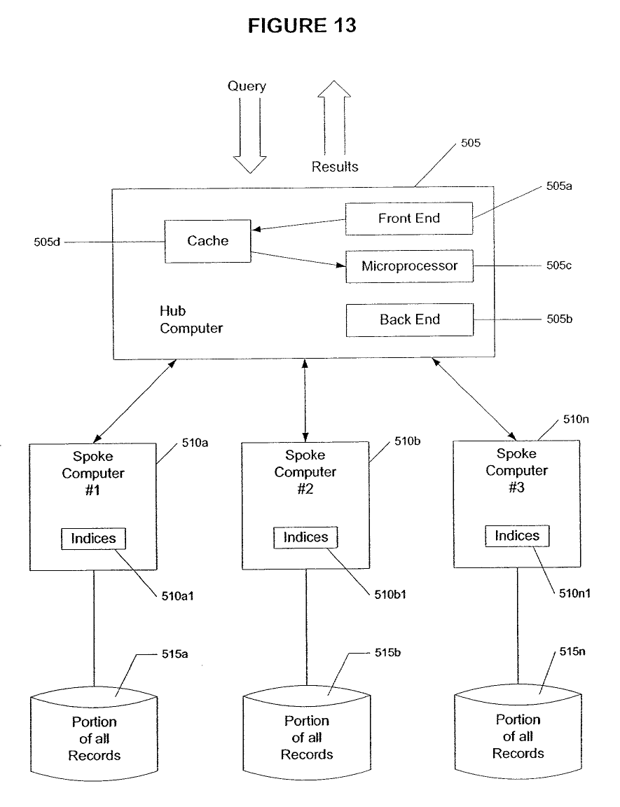

FIG. 13 shows a system overview in accordance with an embodiment of the present invention. Hub computer 505 is the central point. It receives queries from and provides compiled results to users. Hub computer 505 is comprised of front end 505a, back end 505b, microprocessor 505c and cache memory 505d. Front end 505a is used to receive queries from users and format the results so that they are in a compatible format for the user to understand. Back end 505b uses the appropriate protocols to issue broadcast messages and receive messages. Coupled to hub computer 505 are spoke computers 510a, 510b through 501n. Spoke computers 510a-510n have local memories 510a1-510n1 that are used to store indices. Coupled to each spoke computer 510a-510n is large memory storage 515a-515n used to store the electronic records in electronic product catalog 905.

In a preferred embodiment of the present invention, hub computer 505 and spoke computers 510a-510n are Intel-based machines. The communications between the hub computer 505 and spoke computers 510a-510n are based on the TCP/IP format. Spoke computers 510a-510n operate using a custom software written in C++ or Visual Basic. Hub computer 505 uses Visual Basic and C++ to process data.

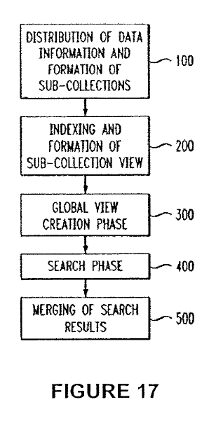

FIGS. 17 through 22 show a method and an apparatus for the efficient and effective distribution, storage, indexing and retrieval of data information in a distributed data retrieval system which is fault tolerant. Large amounts of data may be searched faster by distribution of the data, separate indexing of that distributed data, and creation of a global index on the basis of the separate indexes. A method and apparatus for accomplishing efficient and effective distributed information management will thus be shown below.

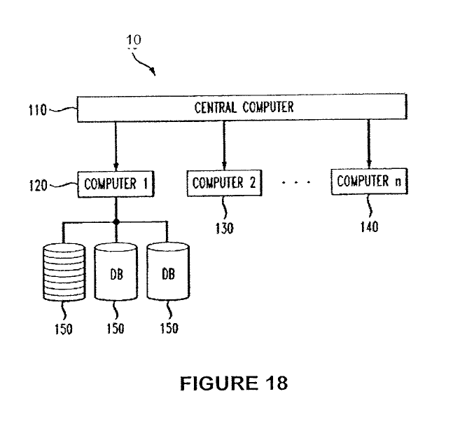

Referring to FIGS. 17 and 18, in step 100 of FIG. 17 data information is distributed and formulated into sub-collections 150 of FIG. 18. The process of distributing the data may be accomplished by sending the data from a central computer terminus 110 to local nodes 120, 130 and 140 of a computer network 10, or by directly entering the data at the local nodes 120, 130 and 140. Further, the data may be divided such that the divided data is of equal or unequal sizes, and so that each division of the data has a relational basis within that division (i.e., each division having an informational subject relation all its own). Such allowances for data entry and distribution allow for little or no change to current data entry and distribution protocols. In the case of the Web, data entry can continue as it does now. Each entity (i.e., Manufacturers, Distributors, Retailers, etc.) can continue to enter data as it sees fit. Thus, the sub-collections 150 can be organized in any fashion and be of any size.

In step 200 of FIG. 17, the data information, which has been divided and stored into the sub-collections 150, is indexed and a “sub-collection view” is formed. Indexing of the sub-collection 150, like the step of distributing the data, can follow current protocols and may be computer-assisted or manually accomplished. It is to be understood, of course, that the present invention is not to be limited to a particular indexing technique or type of technique. For instance, the data may be subjected to a process of “tokenization”. That is, electronic records containing the data are broken down into their constituent words. The resulting collection of words of each document is then subject to “stop-word removal”, the removal of all function words such as “the”, “of” and “an”, as they are deemed useless for document retrieval. The remaining words are then subject to the process of “stemming”. That is, various morphological forms of a word are condensed, or stemmed, to their root form (also called a “stem”). For example, all of the words “running”, “run”, “runner”, “runs”, . . . , etc., are stemmed to their base form run. Once all of the words in the document have been stemmed, each word can be assigned a numeric importance, or “weight”. If a word occurs many times in the document, it is given a high importance. But if a document is long, all of its words get low importance. The culmination of the above steps of indexing convert a document into a list of weighted words or stems. These lists of weighted words or stems are thus in the form:

document.sub.1 .fwdarw.word.sub.1, weight.sub.1 ; word.sub.2, weight.sub.2; . . . ; word.sub.n, weight.sub.n.

Alternatively, the same indexing of the sub-collection can also be achieved using a bitmapped indexing technique.

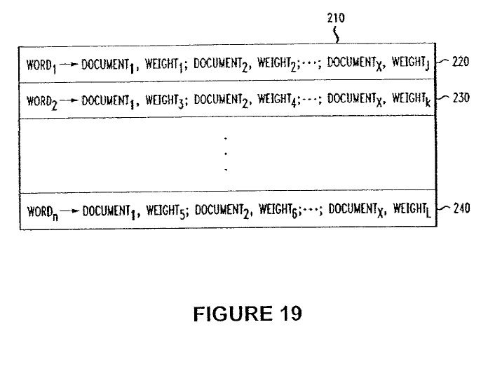

Regardless of the indexing technique used above, the index thus far created is then inverted and stored as an “inverted index”, as shown in FIG. 19. Inversion of the index requires pulling each word or stem out of each of the electronic records of the index and creating an index based on the frequency of appearance of the words or stems in those electronic records. A weight is then assigned to each document on the basis of this frequency. Thus, the inverted index, has the form of:

word.sub.1 .fwdarw.document.sub.a, weight.sub.a; document.sub.b, weight.sub.b; . . . ; document.sub.z, weight.sub.z.

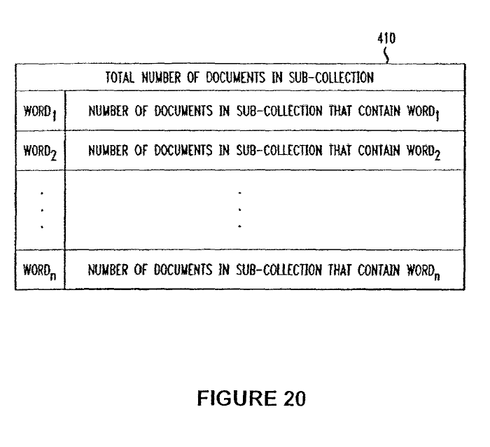

The inverted index 210 itself, as shown in FIG. 19, is composed of many inverted word indexes 220, 230 and 240, and can thus be created and organized. As shown, each inverted word index 220, 230 and 240 composes an index of a different word, taken from the electronic records of the initial index, such that each document is weighted in accordance with the frequency of appearance of the word in that document. Completion of the inverted index 210 allows the derivation of statistical information relating to each word and thus the creation of a sub-collection view 410, as shown in FIG. 20. The statistical information which makes up the sub-collection view 410 includes the total number of electronic records in the sub-collection 150 and, relating to each word, the number of electronic records in the sub-collection that contain that word. As each computer is indexing its sub-collection separately, the total indexing time for indexing the entire collection is greatly reduced as it is now shared across many computers. It is to be understood, of course, that any method of indexing may be used to form the sub-collection view 410 and that the above described method is but one of many for accomplishing that goal.

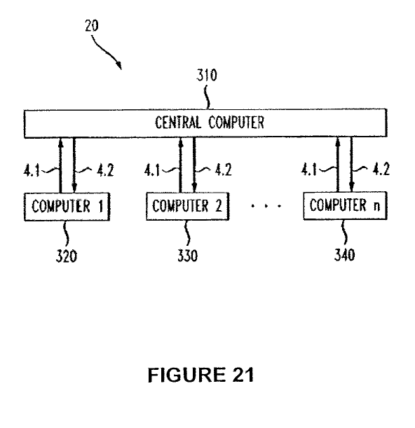

In step 300 in FIG. 17, once the sub-collection view 410 is created, a global view is created and distributed. For formation of the global view, each sub-collection view 410 which has been created is collected from the local nodes 120, 130 and 140 of the computer network 10 and sent to the central computer 110. Referring to FIG. 21, showing an embodiment of the paths of communication of a computer network 20, sub-collection views from computers 320, 330 and 340 are sent to central computer 310 along communication paths 4.1. Collection and sending of the sub-collection view can be initiated by either the central computer 310 or the local computers 320, 330 and 340. If collection of the sub-collection views 410 is initiated by the central computer 310, it may be initiated by individual commands sent to each computer in the network 20, or as a group command sent to all of the computers in the network 20. If the collection of the sub-collection views 410 is initiated by the local computer 320, 330 or 340, then the local computer may send the sub-collection view upon occurrence of completion of the sub-collection view, an update of the sub-collection view, or some other criteria, such as a specific time period having elapsed, etc. It is to be understood, of course, that any method by which the completed sub-collection views are sent to the central computer from the local computers is acceptable.

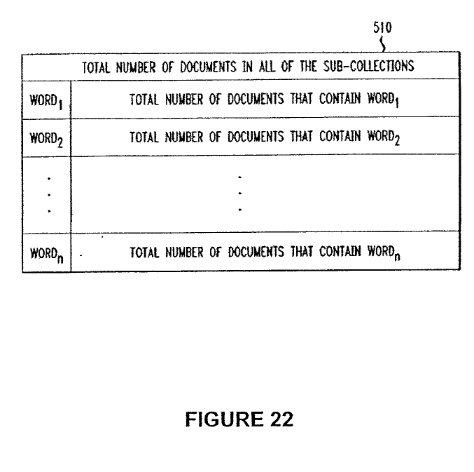

Upon collection of all of the sub-collection views 410, a global view 510 is created as shown in FIG. 22. In the formation of the global view 510, the central computer 310 uses the sub-collections 410 that have been sent from every local computer 320, 330 and 340 to determine how many electronic records are contained in the sub-collection residing at the particular local computer, and for every word, how many electronic records in the sub-collection contain the word in question. The global view 510 then comprises information pertaining to how many electronic records there are in all of the sub-collections (i.e., the total document sum) and for every word, how many electronic records in all of the sub-collections contain the word in question. The global view, then, provides all of the necessary information for use in weighting the words in a user query, as will be explained below. It is to be understood, of course, that any method which provides the central computer with the information necessary to form the global view may be used. For instance, the sub-collection views need not be sent in their entirety themselves, but instead the nodes could send only statistical information about their subcollection(s).

To complete step 300 of FIG. 17, the global view 510 is sent from the central computer 310 to each of the local computers 320, 330 and 340 by way of communication paths 4.2 (as shown in FIG. 21). Thus each local node in the network will now have the global view. It is to be understood, of course, that the description of the formation of the sub-collection views and subsequent formation of the global view can be conducted on any computer network, and thus computer networks 10 and 20 are to be considered interchangeable in this description.

In step 400 of FIG. 17, the search phase is conducted. The search phase refers to search and retrieval of data information stored in the large data text corpora. Thus, to begin with, in the search phase a search query is entered and uploaded by a system user into the computer network 10. It is to be understood, of course, that the system user may enter the search query at any computer location that is connected to the computer network 10. Upon entry of the search query, the search query is transmitted by the computer network 10 to all of the local computers 120, 130 and 140 in the computer network 10.

After receiving the search query, each local computer 120, 130 and 140 then indexes the search query using the same steps that are used to index the electronic records, namely, for instance, “tokenization”, “stop word removal” and “stemming” and “weighting”. The resulting words (actually stems) in the query are assigned importance weights using the global view 510 which each local computer 120, 130 and 140 received in step 300. If a query word is used in many electronic records, then it is presumed to be common and is assigned a low importance weight. However, if a handful of electronic records use a query word, it is considered uncommon and is assigned a high importance weight. The “total number of electronic records in the collection” and the “number of electronic records that use the given word” statistics are only available to local computers 120, 130 and 140 after the global view creation.

It is to be noted, of course, that other formulae might be used as desired. If so, the sub-collection view may be adjusted to account for the different formula. It should also be noted that having each local computer perform an indexing of the search query might be necessary if the entry point of the search query is at a point which does not have access to the global view and thus cannot perform the indexing function. However, if the entry point for the search query does have access to the global view, then the search query can be indexed at the entry point and distributed in an indexed format.

The indexing of the search query, as shown above, yields a weighted vector for the search query of the form:

query.fwdarw.word.sub.1, weight.sub.1; word.sub.2, weight.sub.2; . . . ; word.sub.n, weight.sub.n.

Having indexed the search query, a simple formula is used to assign a numeric score to every document retrieved in response to the search query. This simple formula is referred to as a “vector inner-product similarity” formula. Such a formula can assign a weight to each word in the search query and a weight to each word in the document being scored. Each document is then sent to the central computer 310, via communication paths 4.1, from the local computer nodes 320, 330 and 340.

In step 500 of FIG. 17, once all search results have been returned to the central computer via communication paths 4.1, the central computer 310 merges the variously retrieved electronic records into a list by comparing the numeric scores for each of the electronic records. The scores can simply be compared one against the other and merged into a single list of retrieved electronic records because each of the local computers 320, 330 and 340 used the same global view 510 for their search process. Upon completion of the merging of the electronic records, a complete list is presented to the system user. How many of the electronic records are returned to the user can, of course, be pre-set according to user or system criteria. In this manner then, only the electronic records most likely to be useful, determined as a result of the system user's search query entered, are presented to the system user.

It should be noted that the manner in which the global view 510 is created provides a fault tolerant method of distributing, indexing and retrieving of data information in the distributed data retrieval system. That is, in the case where one or more of the sub-collection views is unable to be collected by the central computer, for whatever reason, a search and retrieval operation can still be conducted by the user. Only a small portion of the entire collection is not searched and retrieved. This is because failure by one or more local computers results in only the loss of the sub-collections associated with those computers. The rest of the data text corpora collection is still searchable as it resides on different computers.

Further, to provide even more fault tolerance, data information may be duplicatively stored in more than one sub-collection. Duplicative storage of the data information will protect against not including that data information in a search and retrieval operation if one of the sub-collections in which the data information is stored is unable to participate in the search and retrieval.

Thus the foregoing embodiment of the method and apparatus show that efficient and effective management of distributed information can be accomplished. The current invention of the division of the large data text corpora into sub-collections which are then separately indexed, which indexes are then used to form a global view, is possible, as shown herein, without a loss and, in fact, an increase in the effectiveness and efficiency of a search and retrieve system. Further, the search and retrieval operations take less time than current systems which either search the entire large collection all at once or which search individual collections.

This system implements the search queries described above in the following manner. First, hub computer 505 receives a query from the user. This query can be in the form of a search term, a taxonomy selection, a category selection, a sub-category selection, etc. Upon reception of the query, microprocessor 505c compares the query with data stored in cache 505d. If the response to the query is already stored in cache 505d, the microprocessor 505c returns that response as a result to the user. Hub computer 505 then waits for another query from the user.

If the query is not in cache 505d, microprocessor generates a broadcast message to be sent to all spoke computers 510a-510n. This broadcast message includes the user's query.

Upon reception, each spoke computer 510a-510n performs a search of the appropriate index stored therein using the query from the user. In a preferred embodiment of the present invention, each spoke computer 510a-510n stores all three indices 910, 915a and 915b in local memory as described above. In addition to broadcasting a request across the network to different machines, multiple threads could be used and the message could be broadcast to multiple processors in a single machine (on a bus rather than a network). Alternatively, the search request could be conducted locally—a single process, single thread, single machine search.

Also in the preferred embodiment, data storage 515a-515n each stores only a portion of the electronic records in electronic product catalog 905. Since each set of data is unique in data storage 515a-515n, it follows that the relationships between the indices stored in local memories 510a1-510n1 are also unique because they cannot all access the same electronic records. In an alternate embodiment, spoke computers 515a-515n all share identical copies of electronic product catalog 905, but the indices 910, 915a, and 915b are parsed among local memory 510a-510n.

In another preferred embodiment of the present invention, the system and method of the present invention can be performed locally using a single process, single thread, single machine system.

Each spoke computer 510a-510n returns the results, either a list or the counts for each category, determined by its respective indices to hub computer 505. Hub computer 505 compiles those results and provides them to the user. In an alternate embodiment, spoke computers 515a-515n are also provided with cache memories to reduce the number of queries made to memories 515a-515n.

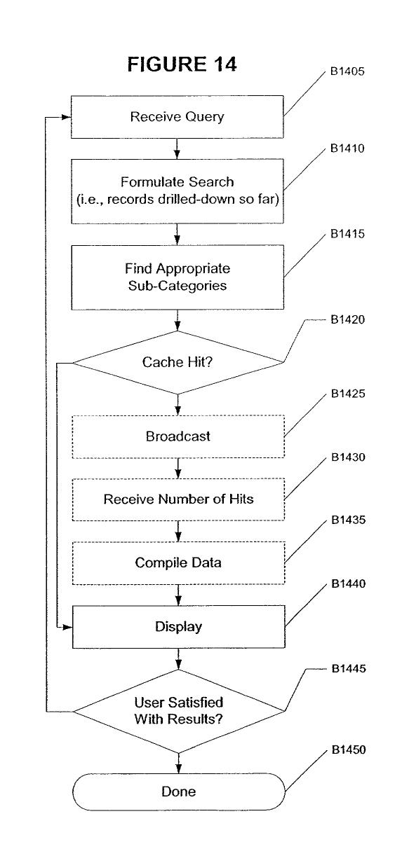

FIG. 14 is a system in accordance with the present invention. At block B1405, the system receives a query from the user. It should be noted that the query may be a term, a taxonomy, a category, a sub-category, a sub-sub-category, free text, a field, a numeric range, Boolean logic, combinations of elements, etc. At block B1410, the query is formulated with respect to the current state of the present search. As an example, if the user enters a keyword query, the query is formulated such that the current taxonomy is taken into consideration.

At block B1415, the system determines the appropriate categories or sub-categories to search through to locate electronic records that match. As an example, one possible category is “Pants.” From the determinations made in blocks B1410 and B1415, the system has narrowed the number of possible hits by discarding those electronic records that do not conform to the selected category. It should be noted that, in a preferred embodiment, the categories or sub-categories are determined using an organized list such as a B-tree, another electronic product catalog or from the inverted index itself.

At block B1420, the system checks its cache. The cache typically stores three types of data. The first type of data is a query result that was recently performed. Thus if user A issues a query for term X in category Y, and 1 minute later user B makes the identical query, the cache is used to provide the results, instead of determining the results anew. The second type of data stored in the cache is frequently requested queries. Suppose users are, in the aggregate, frequently requesting electronic records on new cars but not requesting electronic records on the disease malaria. The results from this frequently requested query are then stored in the cache. The third type of data is searches that are precompiled because otherwise they would take a long time to perform.

If the query is not in the cache, then the query is broadcast to a plurality of processors operating in parallel at block B1425. It should be noted that blocks B1425, B1430 and B1435 are in dashed lines because they are not requirements of the process in order to be operational, but rather are preferred embodiments that enhance the performance of the process. To be more specific, if the query is found in the cache, then blocks B1425-B1435 are eliminated and the overall time to provide the user with results is reduced. The use of parallel processors operating on either portions of the query or searching only portions of the inverted index also reduces the amount of time it takes to provide a result. Thus, a slower performing system that did not include a cache or parallel processors could also use the present process to generate results.

At block B1430, the system receives the number of electronic records that “hit” on the query provided in block B1405. At block B1435, the hits are compiled and the number of hits per category, as determined in block B1415, is also compiled.

At block B1440, the results are displayed to the user. Typically, these results are organized into categories. However, in a preferred embodiment, the system will display a default list of document hits when there are no sub-categories below the last category selected by the user. This prevents giving the user a listing of categories with 0 document hits because this information is not as useful to the user as to know which category the document hits are located in.

At block B1445, a determination is made based upon the results displayed. If the user is satisfied with the results, the process ends at block B1450. If the user desires to refine the query or drill-down or drill-up further into the electronic product catalog, the process continues with a new query at block B1405.

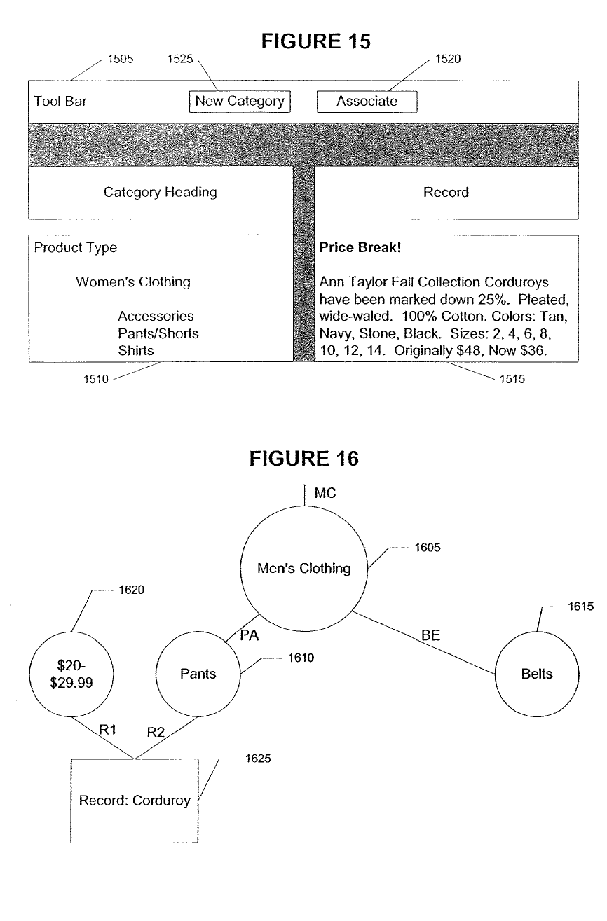

FIG. 15 is a screen shot of a categorizer in accordance with an embodiment of the present invention. This embodiment of a categorizer is a graphic user interface (GUI) that a system operator uses to assist in associating electronic records with categories. Typically, the system operator uses this embodiment of the present invention to insert a new document into an existing category in the taxonomy. Section 1505 is a toolbar that provides such functionality as editing, searching within a document, changing the viewed document, printing, etc. Section 1510 is a graphic representation of the categories in the taxonomy. Section 1515 is a display of the current document.

The system operator scrolls through the taxonomy in section 1510 and the document in section 1515 looking for the best-fit categories for the document displayed in section 1515. When the system operator believes he/she has found a best-fit category for the displayed document, he/she instructs the system to make an association between the best-fit category and the displayed document by clicking button 1520.

In a preferred embodiment of the present invention, the document is scanned by the system before it is displayed. This scanning procedure compares the key terms stored in 910 with the word in the document. When a match is made, the document is highlighted so that the system operator may quickly discern which key terms are in that document. In addition, a count is performed on how many key terms are in this document. The system then queries the various category indices looking for a category title that matches the key term with the most hits in the document. Once that category is determined, that category is displayed along with its parent categories and its sub-categories so as to provide a frame of reference for the system operator. If the system operator agrees with the automatically determined category, he/she clicks on button 1520 to create an association between that determined category and the displayed document. If the system operator does not agree with suggested category and cannot find another suitable category by searching through the list of categories, he/she clicks on button 1525 to instruct the system to create a new category into the hierarchy.

The present invention is not limited to those embodiments described above. For example, the search terms entered by the user need not only be textual. The present invention also includes embodiments that can perform searches on dates, number ranges, proximity (i.e. Is the price of X within the price range Y?), field searches and Boolean searches. In addition, the present invention may be used with other types of queries such as natural language and context-sensitive queries.

Another embodiment of the present invention includes alternative queries placed into the cache. For example, before the first query is processed, precompiled queries such as those that are known to take a long time or are particularly timely, can be pre-loaded into the cache to save time.

The present invention is also not limited to two taxonomies. Any electronic product catalog can be represented by an unlimited number of taxonomies. Alternative embodiments are envisioned that include viewing electronic records by size, promotions, color, brand, price, style, or any other identifiable category structure. Moreover, there is no theoretical limit to the depth of sub-categorization for each taxonomy.

The present invention is also not limited to when certain taxonomies are provided to the user. As described above, the user is presented with the taxonomy last selected. Thus, if the user is using the “Price” taxonomy and enters a new search term, the results will be displayed following the “Price” taxonomy described above. However, in an alternative embodiment, the system can switch taxonomies automatically for the user in an effort to present the search results in a more meaningful manner. For example, if the user selects the final sub-category in the chain, the system will automatically switch over to another taxonomy so as to provide the user with more context and scope regarding the remaining search results. Thus, if there are no sub-categories under “$20-$29.99,” the present invention will switch the taxonomy to “Product Type” so that the user can easily determine how the items that are priced between $20-$29.99 are classified. This switching can also be based on the number of hits. If the category contains only two hits, the system will automatically switch to a different taxonomy to provide the user with more useful information on the remaining electronic records. Similarly, the automatic taxonomy switching may also be based on a particular taxonomy where the number of categories or sub-categories is small. For instance, providing the user with the information that all the hit electronic records are located in one category does not provide any information the user can use to distinguish between these electronic records. Switching to another taxonomy may provide the user with more categories he/she can use to distinguish between the hit electronic records.

It will be appreciated that one preferred embodiment of the present invention is system for searching an electronic product catalog, said system comprising: an organizer configured to receive search requests, said organizer comprising: an electronic product catalog having at least two entries; wherein the electronic product catalog is organized into at least two taxonomies; wherein each of the at least two taxonomies is associated with at least two categories; wherein the entries correspond to at least one of the at least two taxonomies and also correspond to at least one of the at least two categories; and a search engine in communication with the electronic product catalog, wherein said search engine is configured to search based on the at least two taxonomies and based on the at least two categories, wherein the search engine returns, in response to a search request identifying at least a first taxonomy of the at least two taxonomies, a list of the categories associated with the at least first identified taxonomy, along with the number of entries associated with each of the categories associated with the at least first identified taxonomy.

In a preferred embodiment of the present invention, the returned list of categories associated with the first taxonomy, along with the number of entries associated with each of the categories associated with the identified taxonomy can be further searched with regard to a second of the at least two taxonomies, whereby the search engine returns, in response to a search request identifying the second taxonomy of the at least two taxonomies, a list of the categories associated with both identified taxonomies, along with the number of entries associated with each of the categories associated with the second taxonomy.

In another preferred embodiment, the search engine, having returned, in response to a search request identifying a first taxonomy of the at least two taxonomies, a list of the categories associated with the identified taxonomy, along with the number of entries associated with each of the categories associated with the identified taxonomy, will provide only those categories with a non-zero number of entries associated with the identified taxonomy and will further return sub-categories both associated with the category and having a non-zero number of entries associated with the sub-category.

Still further in another preferred embodiment, the search engine, having further returned sub-categories both associated with the category and having a non-zero number of entries associated with the sub-category, will, in response to a search request identifying a second taxonomy of the at least two taxonomies, provide a list of the categories with a non-zero number of entries associated with the second identified taxonomy, along with the number of entries associated with each of the categories associated with the second identified taxonomy.

In another embodiment, the search engine, having returned, in response to a search request identifying a first taxonomy of the at least two taxonomies, a list of the categories associated with the identified taxonomy, along with the number of entries associated with each of the categories associated with the identified taxonomy, will, in response to a string query, provide those entries which both contain the string and are associated with the identified taxonomy. The string is preferably one member of the group consisting of text, image, and graphic.

The present invention can be either a network of computers or a single computer.

The present invention preferably comprises a cache which stores the returned results of the search engine for rapid retrieval.

There are many preferred taxonomies, including at least one taxonomy selected from the group consisting of product type, price, color, size, style, physical characteristics, delivery method, manufacturer, brand, components, ingredients, compatibility, warranty information, model year, age, and version.

In another preferred embodiment of the present invention, the present invention will, in response to a search request identifying one member selected from the group consisting of a taxonomy, a category, and a sub-category, the search engine additionally return an advertising entry. Preferably, the advertising entry is either a banner advertisement or a search-visible storefront..

Various preferred embodiments of the invention have been described in fulfillment of the various objects of the invention. It should be recognized that these embodiments are merely illustrative of the principles of the invention. Numerous modifications and adaptations thereof will be readily apparent to those skilled in the art without departing from the spirit and scope of the present invention.

1. A system for searching an electronic product catalog, said system comprising:
an organizer configured to receive search requests, said organizer comprising:
an electronic product catalog having at least two entries;
wherein the electronic product catalog is organized into at least two taxonomies;
wherein each of the at least two taxonomies is associated with at least two categories;
wherein the entries correspond to at least one of the at least two taxonomies and also correspond to at least one of the at least two categories; and
a search engine in communication with the electronic product catalog,
wherein said search engine is configured to search based on the at least two taxonomies and based on the at least two categories,
wherein the search engine returns, in response to a search request identifying at least a first taxonomy of the at least two taxonomies, a list of the categories associated with the at least first identified taxonomy, along with the number of entries associated with each of the categories associated with the at least first identified taxonomy.

2. The system according to claim 1, wherein the returned list of categories associated with the first taxonomy, along with the number of entries associated with each of the categories associated with the identified taxonomy can be further searched with regard to a second of the at least two taxonomies, whereby the search engine returns, in response to a search request identifying the second taxonomy of the at least two taxonomies, a list of the categories associated with both identified taxonomies, along with the number of entries associated with each of the categories associated with the second taxonomy.

3. The system according to claim 1, wherein the search engine, having returned, in response to a search request identifying a first taxonomy of the at least two taxonomies, a list of the categories associated with the identified taxonomy, along with the number of entries associated with each of the categories associated with the identified taxonomy, will provide only those categories with a non-zero number of entries associated with the identified taxonomy and will further return sub-categories both associated with the category and having a non-zero number of entries associated with the sub-category.

4. The system according to claim 3, wherein the search engine, having further returned sub-categories both associated with the category and having a non-zero number of entries associated with the sub-category, will, in response to a search request identifying a second taxonomy of the at least two taxonomies, provide a list of the categories with a non-zero number of entries associated with the second identified taxonomy, along with the number of entries associated with each of the categories associated with the second identified taxonomy.

5. The system according to claim 1, wherein the search engine, having returned, in response to a search request identifying a first taxonomy of the at least two taxonomies, a list of the categories associated with the identified taxonomy, along with the number of entries associated with each of the categories associated with the identified taxonomy, will, in response to a string query, provide those entries which both contain the string and are associated with the identified taxonomy.

6. The system according to claim 5, wherein the string is one member of the group consisting of text, image, and graphic.

7. The system according to claim 1, wherein the system comprises a network of computers.

8. The system according to claim 1, wherein the system comprises a single computer.

9. The system according to claim 1, wherein the system further comprises a cache which stores the returned results of the search engine for rapid retrieval.

10. The system for searching an electronic product catalog according to claim 1, wherein at least one taxonomy of the at least two taxonomies is selected from the group consisting of product type, price, color, size, style, physical characteristics, delivery method, manufacturer, brand, components, ingredients, compatibility, warranty information, model year, age, and version.

11. The system for searching an electronic product catalog according to claim 1, wherein, in response to a search request identifying one member selected from the group consisting of a taxonomy, a category, and a sub-category, the search engine additionally returns an advertising entry.

12. The system for searching an electronic product catalog according to claim 17, wherein the advertising entry is at least one member selected from the group consisting of a banner advertisement and a search-visible storefront.

13. A system for searching an electronic product catalog, said system comprising:
means for networking a plurality of computers; and
means for organizing executing in said computer network and configured to receive search requests from any one of said plurality of computers, said means for organizing comprising:
an electronic product catalog having at least two entries;
wherein the electronic product catalog is organized into at least two taxonomies;
wherein each of the at least two taxonomies is associated with at least two categories;
wherein the entries correspond to at least one of the at least two taxonomies and also correspond to at least one of the at least two categories; and
means for searching in communication with the electronic product catalog,
wherein said means for searching is configured to search based on the at least two taxonomies and based on the at least two categories,
wherein the means for searching returns, in response to a search request identifying one of the at least two taxonomies, a list of the categories associated with the identified taxonomy, along with the number of entries associated with each of the categories associated with the identified taxonomy.

14. The system according to claim 13, wherein the returned list of categories associated with the first taxonomy, along with the number of entries associated with each of the categories associated with the identified taxonomy can be further searched with regard to a second of the at least two taxonomies, whereby the means for searching returns, in response to a search request identifying the second taxonomy of the at least two taxonomies, a list of the categories associated with both identified taxonomies, along with the number of entries associated with each of the categories associated with the second taxonomy.

15. The system for searching an electronic product catalog according to claim 13, wherein the means for searching, having returned, in response to a search request identifying a first taxonomy of the at least two taxonomies, a list of the categories associated with the identified taxonomy, along with the number of entries associated with each of the categories associated with the identified taxonomy, will provide only those categories with a non-zero number of entries associated with the identified taxonomy and will further provide sub-categories associated with the category and having a non-zero number of entries associated with the sub-category.

16. The system for searching an electronic product catalog according to claim 15, wherein the means for searching, having further returned sub-categories both associated with the category and having a non-zero number of entries associated with the sub-category, will, in response to a search request identifying a second taxonomy of the at least two taxonomies, provide a list of the categories with a non-zero number of entries associated with the second identified taxonomy, along with the number of entries associated with each of the categories associated with the second identified taxonomy.

17. The system for searching an electronic product catalog according to claim 15, wherein the means for searching, having returned, in response to a search request identifying a first taxonomy of the at least two taxonomies, a list of the categories associated with the identified taxonomy, along with the number of entries associated with each of the categories associated with the identified taxonomy, will, in response to a string query, provide those entries which both contain the string and are associated with the identified taxonomy.

18. The system for searching an electronic product catalog according to claim 17, wherein the string is one member of the group consisting of text, image, and graphic.

19. The system for searching an electronic product catalog according to claim 15, wherein the system comprises a network of computers.

20. The system for searching an electronic product catalog according to claim 15, wherein the system comprises a single computer.

21. The system for searching an electronic product catalog according to claim 15, wherein the system further comprises a cache which stores the returned results of the means for searching for rapid retrieval.

22. The system for searching an electronic product catalog according to claim 15, wherein at least one taxonomy of the at least two taxonomies is selected from the group consisting of product type, price, color, size, style, physical characteristics, delivery method, manufacturer, brand, components, ingredients, compatibility, warranty information, model year, age, and version.

23. The system for searching an electronic product catalog according to claim 15, wherein, in response to a search request identifying one member selected from the group consisting of a taxonomy, a category, and a sub-category, the means for searching additionally returns an advertising entry.

24. The system for searching an electronic product catalog according to claim 23, wherein the advertising entry is at least one member selected from the group consisting of a banner advertisement and a search-visible storefront.

25. A method for searching an electronic product catalog, said method comprising:
communicating a search request to a search engine, the search engine being in communication with an electronic product catalog;
wherein the electronic product catalog has at least two entries;
wherein the electronic product catalog is organized into at least two taxonomies;
wherein each of the at least two taxonomies is associated with at least two categories;
wherein the at least two entries correspond to at least one of the at least two taxonomies and also correspond to at least one of the at least two categories;
querying of the electronic product catalog by the search engine based on the communicated search request;
wherein the communicated search request identifies at least one of the at least two taxonomies;
returning of a list of the categories associated with the at least one identified taxonomy, along with the number of entries associated with each of the categories associated with the at least one identified taxonomy as a response to the querying of the electronic product catalog.

26. The method for searching an electronic product catalog according to claim 25, wherein the method further comprises
returning, in response to a search request identifying a second taxonomy of the at least two taxonomies, a list of the categories associated with both identified taxonomies, along with the number of entries associated with each of the categories associated with the second taxonomy.

27. The method for searching an electronic product catalog according to claim 25, wherein the method further comprises
returning a list of only those categories with a non-zero number of entries associated with the identified taxonomy and further returning at least one sub-category associated with the category and having a non-zero number of entries associated with the sub-category.

28. The method for searching an electronic product catalog according to claim 27, wherein the method further comprises
having further returned sub-categories both associated with the category and having a non-zero number of entries associated with the sub-category, providing, in response to a search request identifying a second taxonomy of the at least two taxonomies, provide a list of the categories with a non-zero number of entries associated with the second identified taxonomy, along with the number of entries associated with each of the categories associated with the second identified taxonomy.

29. The method for searching an electronic product catalog according to claim 25, wherein the method further comprises
returning, in response to a string query, provide those entries which both contain the string and are associated with the identified taxonomy.

30. The method for searching an electronic product catalog according to claim 29, wherein the string is one member of the group consisting of text, image, and graphic.

31. The method for searching an electronic product catalog according to claim 25, wherein the system comprises a network of computers.

32. The method for searching an electronic product catalog according to claim 25, wherein the system comprises a single computer.

33. The method for searching an electronic product catalog according to claim 25, wherein the system further comprises a cache which stores the returned results of the means for searching for rapid retrieval.

34. The method for searching an electronic product catalog according to claim 25, wherein at least one taxonomy of the at least two taxonomies is selected from the group consisting of product type, price, color, size, style, physical characteristics, delivery method, manufacturer, brand, components, ingredients, compatibility, warranty information, model year, age, and version.

35. The method for searching an electronic product catalog according to claim 25, wherein the method further comprises
returning by the search engine additionally, in response to a search request identifying one member selected from the group consisting of a taxonomy, a category, and a sub-category, an advertising entry.

36. The method for searching an electronic product catalog according to claim 35, wherein the advertising entry is at least one member selected from the group consisting of a banner advertisement and a search-visible storefront.

37. An article of manufacture comprising:
a computer usable medium having computer program code means embodied thereon for searching an electronic product catalog, the computer readable program code means in said article of manufacture comprising:
computer readable program code means for communicating a search request to a search engine, the search engine being in communication with an electronic product catalog;
wherein the electronic product catalog has at least two entries;
wherein the electronic product catalog is organized into at least two taxonomies;
wherein each of the at least two taxonomies is associated with at least two categories;
wherein the at least two entries correspond to at least one of the at least two taxonomies and also correspond to at least one of the at least two categories;
computer readable program code means for querying of the electronic product catalog by the search engine based on the communicated search request;
wherein a communicated search request identifies at least one of the at least two taxonomies; and
computer readable program code means for returning of a list of the categories associated with the at least one identified taxonomy, along with the number of entries associated with each of the categories associated with the at least one identified taxonomy as a response to the querying of the electronic product catalog.

38. The article of manufacture according to claim 37, wherein the returned list of categories associated with the first taxonomy, along with the number of entries associated with each of the categories associated with the identified taxonomy can be further searched with regard to a second of the at least two taxonomies, whereby the computer readable program code means for querying of the electronic product catalog by the search engine returns, in response to a search request identifying the second taxonomy of the at least two taxonomies, a list of the categories associated with both identified taxonomies, along with the number of entries associated with each of the categories associated with the second taxonomy.

39. The article of manufacture according to claim 37, wherein the computer readable program code means for querying of the electronic product catalog by the search engine, having returned, in response to a search request identifying a first taxonomy of the at least two taxonomies, a list of the categories associated with the identified taxonomy, along with the number of entries associated with each of the categories associated with the identified taxonomy, will provide only those categories with a non-zero number of entries associated with the identified taxonomy and will further provide sub-categories associated with the category and having a non-zero number of entries associated with the sub-category.

40. The article of manufacture according to claim 39, wherein the computer readable program code means for querying of the electronic product catalog by the search engine, having further returned sub-categories both associated with the category and having a non-zero number of entries associated with the sub-category, will, in response to a search request identifying a second taxonomy of the at least two taxonomies, provide a list of the categories with a non-zero number of entries associated with the second identified taxonomy, along with the number of entries associated with each of the categories associated with the second identified taxonomy.

41. The article of manufacture according to claim 37, wherein the means for searching, having returned, in response to a search request identifying a first taxonomy of the at least two taxonomies, a list of the categories associated with the identified taxonomy, along with the number of entries associated with each of the categories associated with the identified taxonomy, will, in response to a string query, provide those entries which both contain the string and are associated with the identified taxonomy.

42. The article of manufacture according to claim 41, wherein the string is one member of the group consisting of text, image, and graphic.

43. The article of manufacture according to claim 37, wherein at least one taxonomy of the at least two taxonomies is selected from the group consisting of product type, price, color, size, style, physical characteristics, delivery method, manufacturer, brand, components, ingredients, compatibility, warranty information, model year, age, and version.

44. The article of manufacture according to claim 37, wherein, in response to a search request identifying one member selected from the group consisting of a taxonomy, a category, and a sub-category, the search engine additionally returns an advertising entry.

45. The article of manufacture according to claim 44, wherein the advertising entry is at least one member selected from the group consisting of a banner advertisement and a search-visible storefront.
